(19) United States
(12) Patent Application Publication
(10) Pub. No.: US 2007/0188491 A1
(43) Pub. Date: Aug. 16, 2007

(54) System and method for fast efficient contour shading of sampled data

(75) Inventors: Kevin Denelsbeck, Melbourne, FL (US); Stephen Burch, Oak Hill, FL (US)

Correspondence Address: NIXON PEABODY, LLP, 401 9TH STREET, NW, SUITE 900, WASHINGTON, DC, 20004-2128, US

(73) Assignee: ENSCO, INC., Falls Church, VA (US)

(21) Appl. No.: 11/637,192

(22) Filed: Dec. 12, 2006

Related U.S. Application Data
(60) Provisional application No. 60/749,078, filed on Dec. 12, 2005.

(51) Int. Cl. G06T 15/50

(52) U.S. Cl. 345/426

(57) ABSTRACT

A system and method for fast efficient contour shading of spatially sampled data presents accurate contour regions. The system and method render a contour graphic for display by obtaining a set of gridded data, dividing the set of gridded data into tiles, analyzing each tile sequentially to determine contour levels within each tile from lowest contour level to highest contour level, creating a contour region based upon the determined contour levels, drawing contour lines based upon the determined contour levels, shading the contour regions, and providing the shaded contoured region for display. The system and method make a single pass through the gridded data rather than exhaustively detecting contour levels of interest and following the detected levels of interest through the grid of data using analytic and interpolative approaches.

### CROSS-REFERENCE TO RELATED APPLICATION

This application claims the benefit of priority of U.S. Provisional Application Ser. No. 60/749,078, filed on Dec. 12, 2005, entitled “System and Method for Fast Efficient Contour Shading of Two-Dimensional Sampled Data.”

### FIELD OF THE INVENTION

The present invention relates to analyzing and presenting sampled data, such as topographic information or meteorological phenomena. More particularly, it relates to systems and methods for analyzing spatially-sampled data for rendering contour regions piecewise in one pass through gridded data.

### BACKGROUND OF THE INVENTION

On a computer display or on a folded paper in a glove compartment, a map is one of the best tools available to catalog and view the arrangement of things on the Earth's surface. Maps of various kinds, including road maps, political maps, land use maps, and maps of the world, serve many different purposes.

One of the most widely used of all maps is the topographic map. Topographic maps render the three-dimensional ups and downs of the terrain on a two-dimensional surface. The feature that most distinguishes topographic maps from maps of other types is the use of contour lines to portray the shape and elevation of the land. A contour line (also known as a “level set”, “isopleth”, “isogram”, or “isarithm”) for a function of two variables is a curve connecting points where the function has a same particular value. The value for a particular contour line or contour color is called the “contour level.” In cartography, for example, a topographic map may be illustrated with contour lines connecting two points with similar physical characteristics, such as elevation, temperature, humidity, and the like. Contour lines create closed regions on a map. These regions may be filled-in with different colors or shading according to a color scale to indicate elevations or otherwise illustrate value ranges between adjacent contour levels for the variable under consideration.

Topographic maps may portray both natural and manmade features. They show and name works of nature including mountains, valleys, plains, lakes, rivers, and vegetation. They also identify the principal works of man, such as roads, boundaries, transmission lines, and major buildings.

The wide range of information provided by topographic maps make them extremely useful to professional and recreational map users alike. Topographic maps are used for engineering, energy exploration, natural resource conservation, environmental management, public works design, commercial and residential planning, and outdoor activities like hiking, camping, and fishing.

To measure the land area under examination, the area to be mapped must first be photographed from the air. Each section of ground is photographed from two different angles to provide a stereoscopic three-dimensional image that can be converted into contour lines. Each section of the ground that is photographed represents a discrete sample of the land area under examination. Aircraft are flown over the area at a constant altitude in a single direction along carefully determined flight paths while special cameras take precisely positioned photographs of each quadrangle under examination. To ensure the accuracy of a map, the exact location of various control points are established by field surveys. Typical control points may be the intersection of two roads or other prominent features within the map area. Horizontal control points are surveyed to determine the longitude and latitude, while vertical control points are surveyed separately to determine elevations. The location and elevation of these control points help the map makers correctly position the aerial photo images and assign values to the contour lines.

A common problem in analysis of spatially-sampled data, such as topographic information or meteorological phenomena, is establishing where contour lines of similarly-valued data lie. Such lines might be elevation levels of a hill or isobars of barometric pressure. Ideally, the sampling method would “know” a priori which contour levels are desired and painstakingly track these values throughout the sampling space, leading to precisely-drawn contour regions of substantial accuracy. Unfortunately, practicality usually permits only coarse sampling in a regular pattern, meaning that sample points are relatively far apart, usually gridded, with no effort attempted to detect or trace contour levels of interest. Only after the samples are collected does contour tracing occur, thus requiring a posteriori interpolative or curve-fitting approaches.

Most previous efforts at contour-tracing adopt a “holistic” method where a contour level of interest is detected, then followed through the grid of data using various analytic and interpolative approaches until the contour line is established to be either edge-to-edge (of the sampling area) or connected back on itself. This process is repeated until all contour lines have been synthesized from the data. If contour shading is desired, then the contour regions must be constructed from the existing contour lines. This often necessitates one or more rounds of constructive area geometry (CAG) operations, as some contour regions are usually nested inside others and the “outer” regions are not homeomorphic to simple closed regions such as circles. Each “band” of elevation around the summit of a hill, for example, is homeomorphic to a 2D-annulus, which is not a drawing primitive in most graphic display systems. Identification of the band's boundaries, and decomposition into a connected strip of triangles, can be costly, especially in the presence of multiple contour levels in densely-sampled data. Each band is typically created as the subtraction of an “inner” closed region from an encompassing one, an operation that computationally is not trivial.

Efforts to date to improve the speed and accuracy of contour-tracing and contour shading have focused on increasing the horsepower of the analytic engines used to carry out the contour-tracing and contour shading analysis with little attention focused on improved methods of conducting the analysis. What is needed is a system and a method for fast efficient contour determination and shading of sampled data.

### SUMMARY OF THE INVENTION

The present invention relates to a system and method for analyzing and presenting sampled data, such as topographic information or meteorological phenomena. The present invention provides a simple, powerful, and elegant manner for analyzing spatially-sampled data for rendering contour regions piecewise in one pass through gridded data.

The system of the present invention avoids the potentially-spiraling costs of Constructive Area Geometry (CAG) operations by drawing contour regions piecewise as the method of the present invention analyzes the collected information by making one pass through the gridded data. Rather than using CAG to create new geometric objects by performing Boolean operations on existing objects, the present invention divides the gridded data into rectangular cells, or tiles, where each tile's corners are the sampled data from a particular cell in the gridded data. The method of the present invention then analyzes each tile for desired contour levels, working our way sequentially from “lowest” to “highest” contour level, creating and shading contour regions as we go. When the analysis is complete on a tile, the method of the present invention never has to revisit that tile, and the method proceeds on to the next one. Similarly, the method of the present invention may work sequentially from “highest” to “lowest” contour level, or in any predetermined sequential scheme.

The system of the present invention obtains a set of gridded data. The gridded data is divided into tiles. Each tile is analyzed sequentially to determine contour levels within each tile in a predetermined order, such as in ascending or descending order. The invention then creates a contour region based upon the determined contour levels. The invention may then shade the contour regions and make the shaded contoured region available for display.

### BRIEF DESCRIPTION OF THE DRAWINGS

The accompanying drawings illustrate an embodiment of the invention and depict the above-mentioned and other features of this invention and the manner of attaining them. In the drawings:

FIG. 1 illustrates an example grid of contour values from which contour lines may be drawn.

FIGS. 2A-2P illustrate a conventional method of drawing contour lines on a set of gridded data.

FIGS. 3A-3J illustrate a conventional method of shading contour levels on a set of gridded data.

FIGS. 4A-4B illustrate complicated contour shading gridded data sets.

FIG. 5 illustrates a linear interpolation process used in accordance with the present invention.

FIGS. 6A-6U illustrate a method of drawing and shading contour regions in accordance with the present invention.

FIGS. 7A-7G illustrate analysis and shading of complicated data sets using a system and method of the present invention.

FIGS. 8A-8C illustrate evaluation, mapping, and shading of complex gridded data sets of wind speeds around the world.

FIG. 9 illustrates a contour map with pathological data conditions.

FIGURES 10A-10C illustrate a cornered contour level pathological data condition.

FIGS. 11A-11D illustrate an ambiguous path pathological data condition.

FIG. 12 illustrates a computer system in accordance with the present invention.

FIG. 13 illustrates a contour module for use in a system in accordance with the present invention.

FIGS. 14-18 illustrate an overview of a contouring method using a circularly linked coordinate list in accordance with the present invention.

FIGS. 19-50 illustrate a detailed view of a contouring method using a circularly linked coordinate list in accordance with the present invention.

### DETAILED DESCRIPTION OF THE INVENTION

The following detailed description of the invention refers to the accompanying drawings and to certain preferred embodiments, but the detailed description of the invention does not limit the invention. The scope of the invention is defined by the appended claims and equivalents as it will be apparent to those of skill in the art that various features, variations, and modifications can be included or excluded based upon the requirements of a particular use.

The present invention extends the functionality of current contouring systems and methods of contouring by dividing gridded data sets into tiles and sequentially determining contour levels within each tile in a predetermined order. The system and method of the invention then creates and shades a contour region based upon the determined contour levels. The system and method of the present invention has many advantages over prior systems because the contouring is performed much more quickly than with previous systems and is robust in the face of pathological cases. That is, cases where the sampled data present an ambiguous path for a contour level to be drawn.

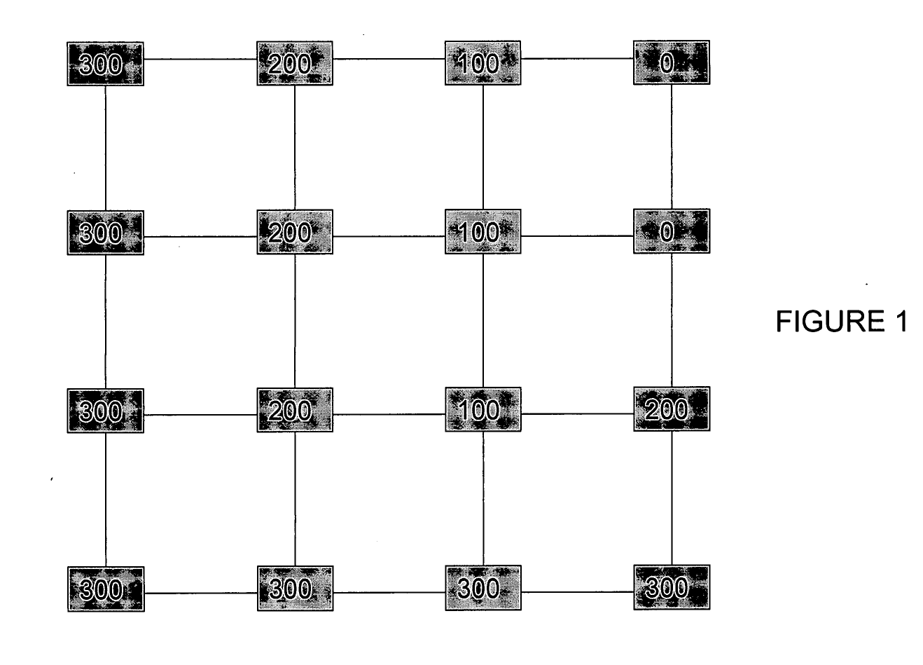

A system and method of the present invention may be illustrated by using an example data grid of contour values, such as that illustrated in FIG. 1. The example data grid of FIG. 1 may be used to illustrate the manner in which conventional contouring systems determine contour levels as well as the manner in which the system and method of the present invention performs this analysis. By comparing and contrasting the manner in which the systems perform this analysis, features and benefits of the present invention are readily apparent.

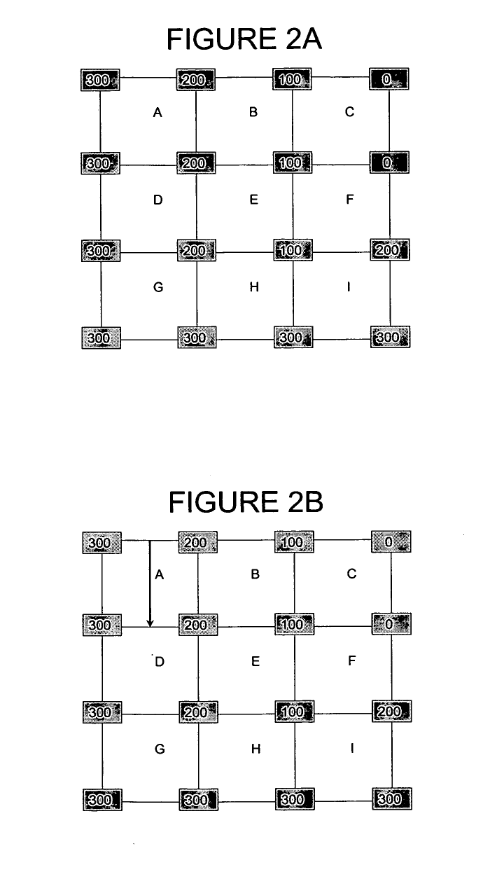

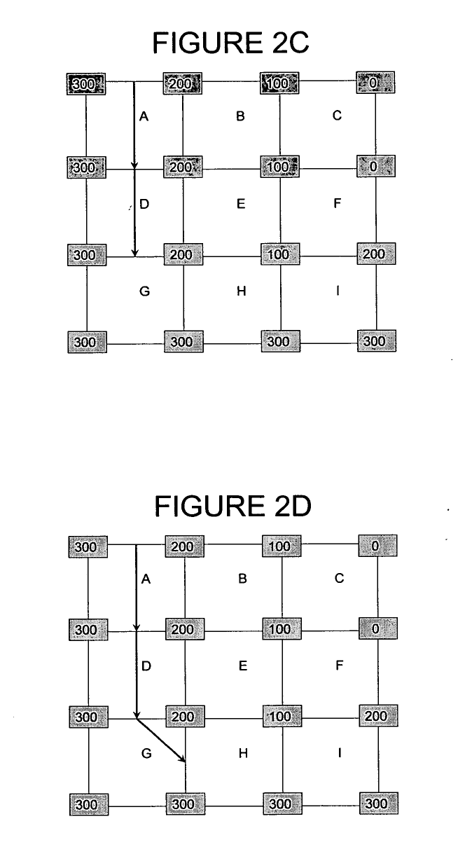

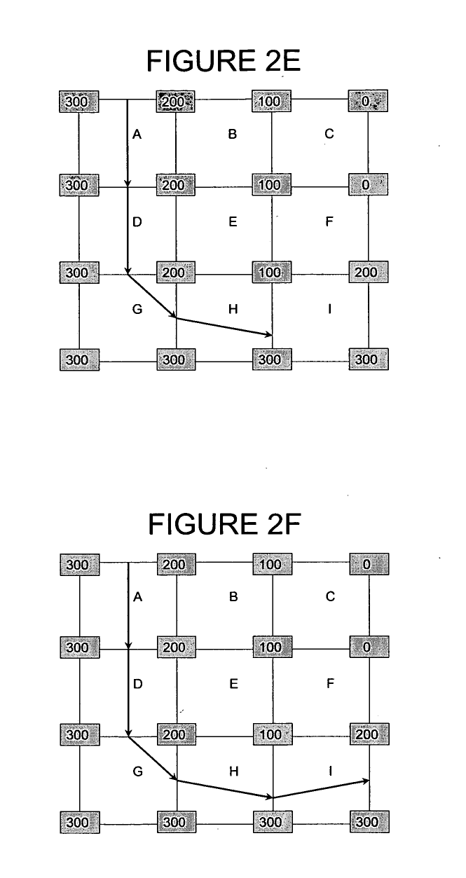

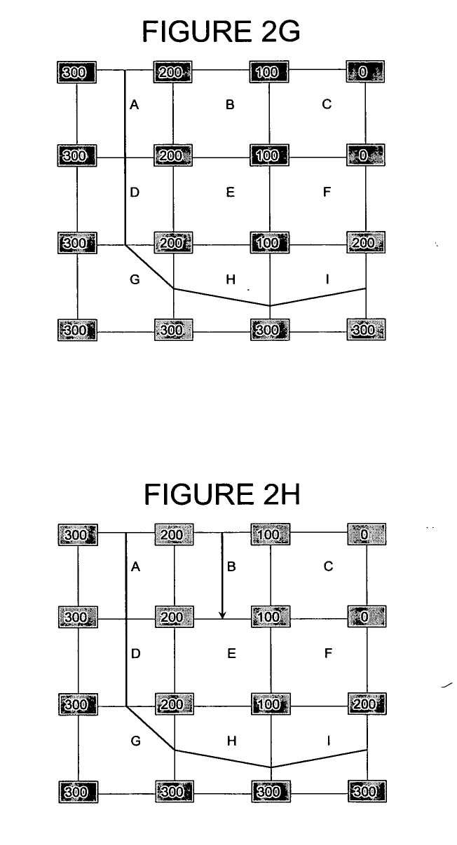

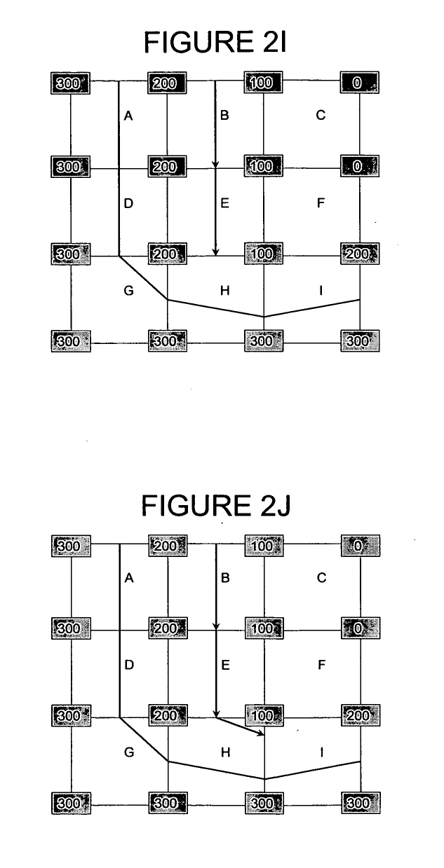

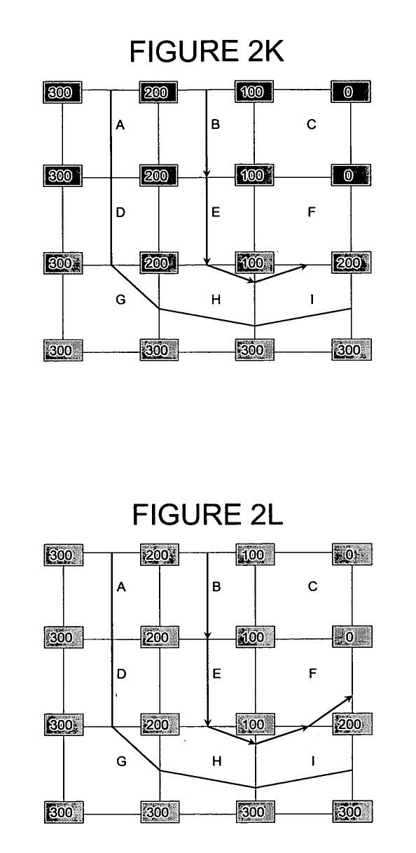

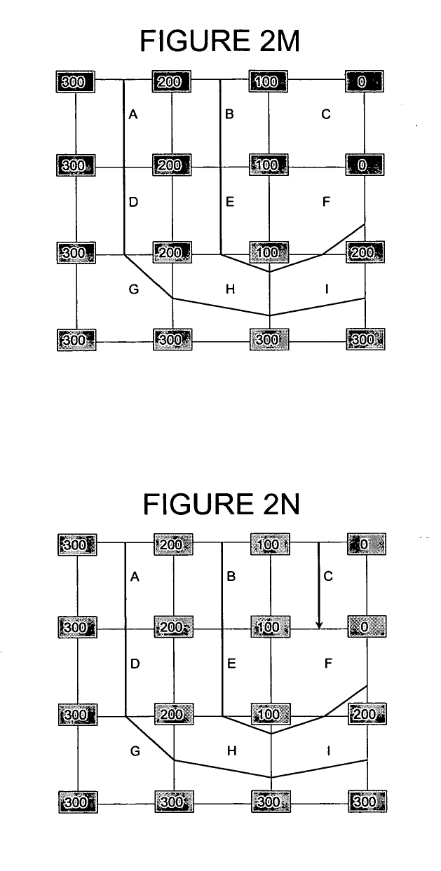

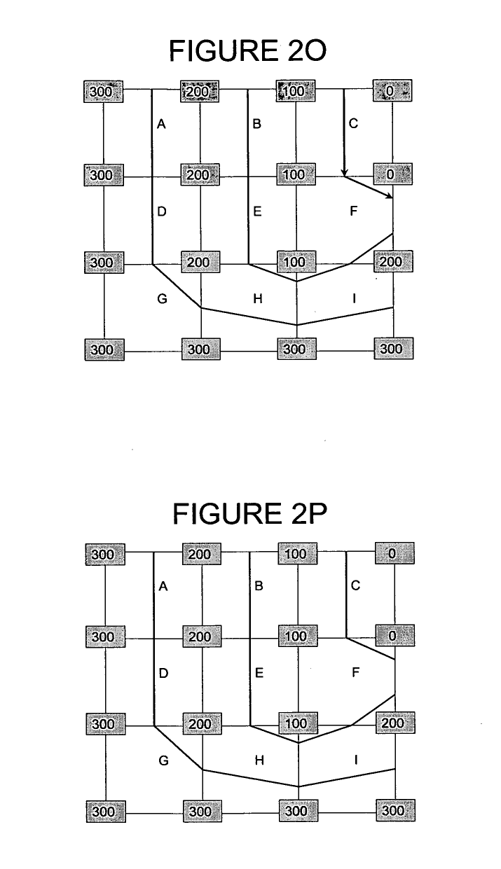

FIGS. 2A-2P illustrate the conventional approach to contouring. As shown beginning in FIG. 2A, historical systems start at the top row and look for a particular contour level. The traditional approach to contouring has been to “follow” the contour level through the grid cells (labeled in FIG. 2A as A, B, C, D, E, F, G, H, I) and to stop “following” when the contour level either hits an edge of the grid or connects with itself. This process is typically repeated for each cell and for each contour level.

For example, three contour levels of 250, 150, and 50 are to be drawn on the example grid. The 250 level is to be drawn first, then the 150 level, and then the 50 level. FIG. 2A shows the grid just prior to the start of contouring. FIG. 2B illustrates the first drawn 250 contour in grid cell A. In FIG. 2C, the 250 contour line is followed to the next cell D. Likewise, in FIG. 2D, the 250 contour line is followed to the third cell G. In FIG. 2E, the 250 contour line is followed again to cell H and finally to cell I in FIG. 2F. FIG. 2G illustrates the complete 250 contour line on the example grid.

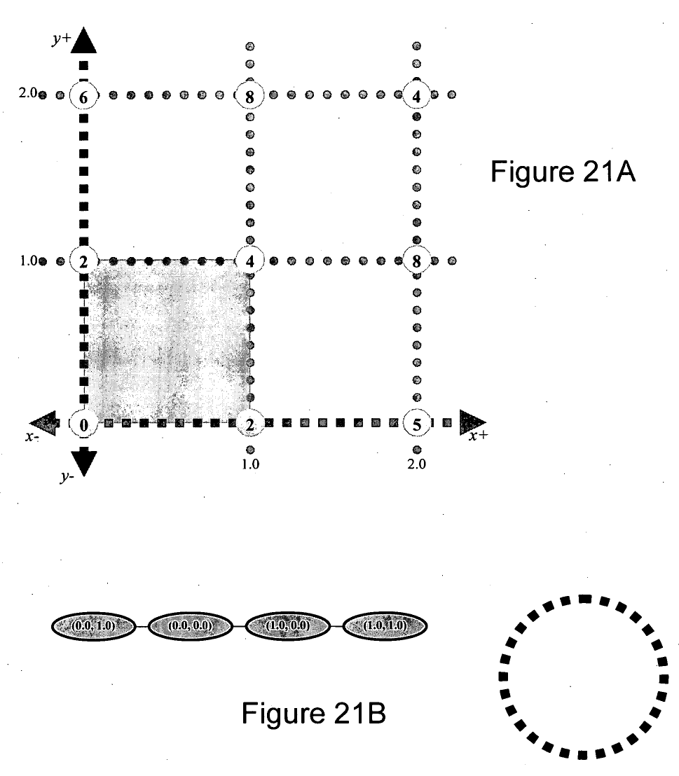

Next, the 150 contour level is drawn. In FIG. 2H, the 150 contour is drawn in grid cell B. In FIG. 21, the 150 contour line is followed to the next cell E. Likewise, in FIG. 2J, the 150 contour line is followed to a third cell H. The 150 contour line is followed again to cell I in FIG. 2K and finally to cell F in FIG. 2L. FIG. 2M illustrates the complete 150 contour line on the example grid.

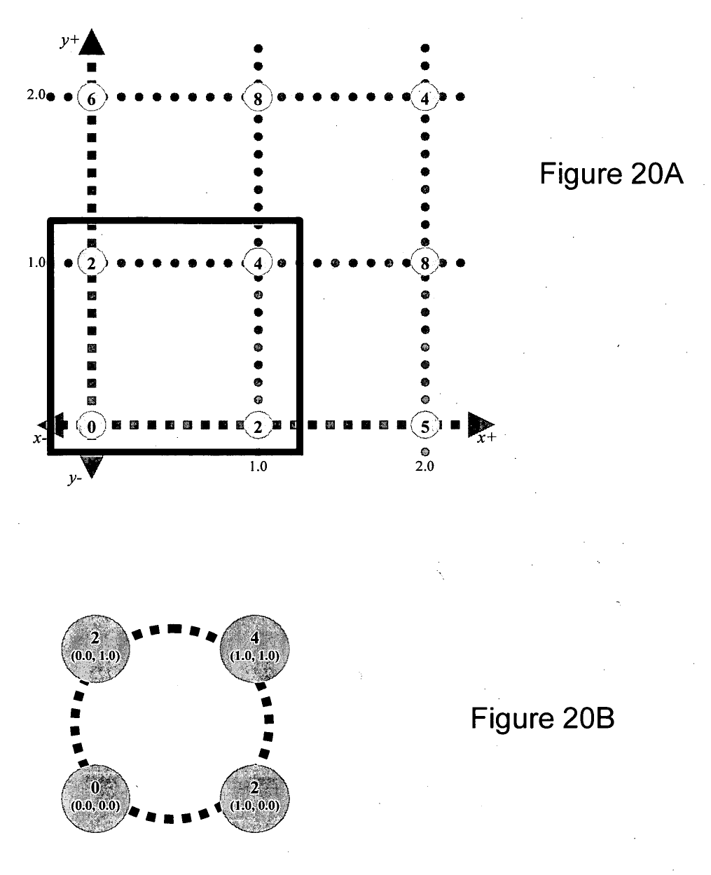

Similarly, in FIG. 2N, the 50 contour is drawn beginning in grid cell C. In FIG. 20, the 50 contour line is followed to the next cell F. FIG. 2P illustrates the complete 50 contour line on the example grid.

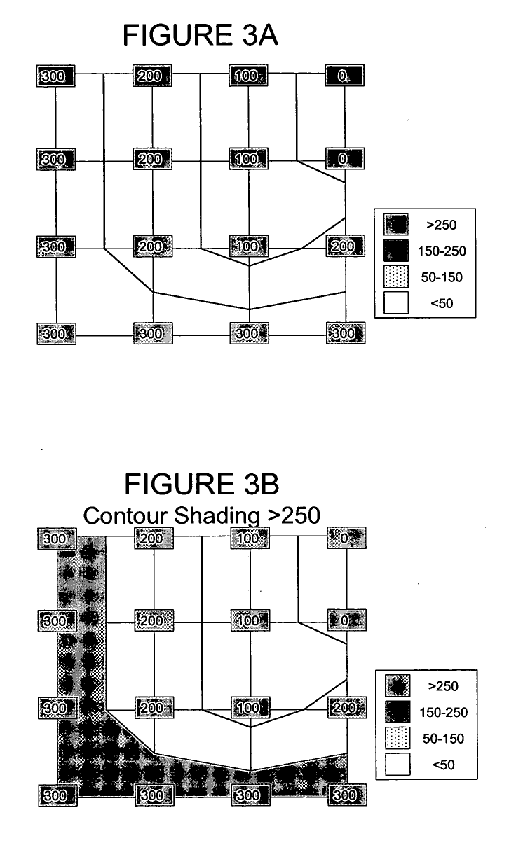

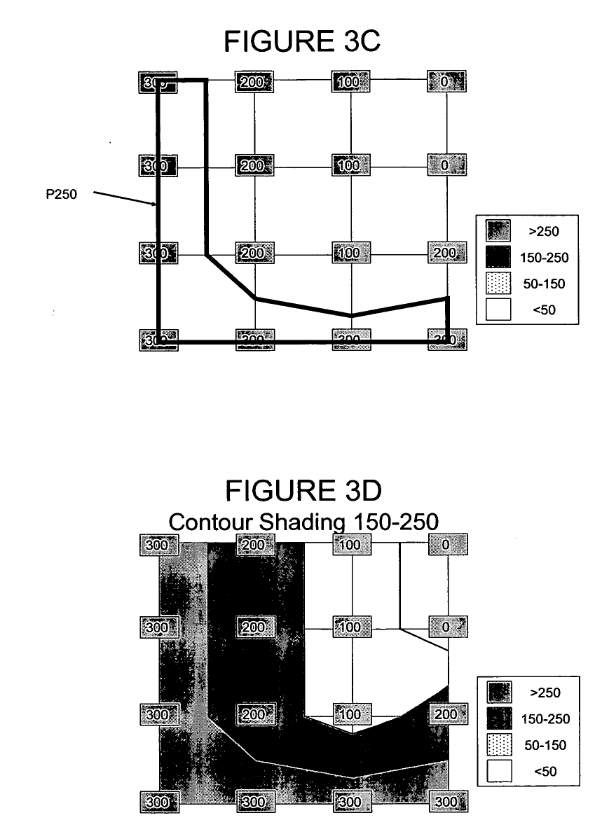

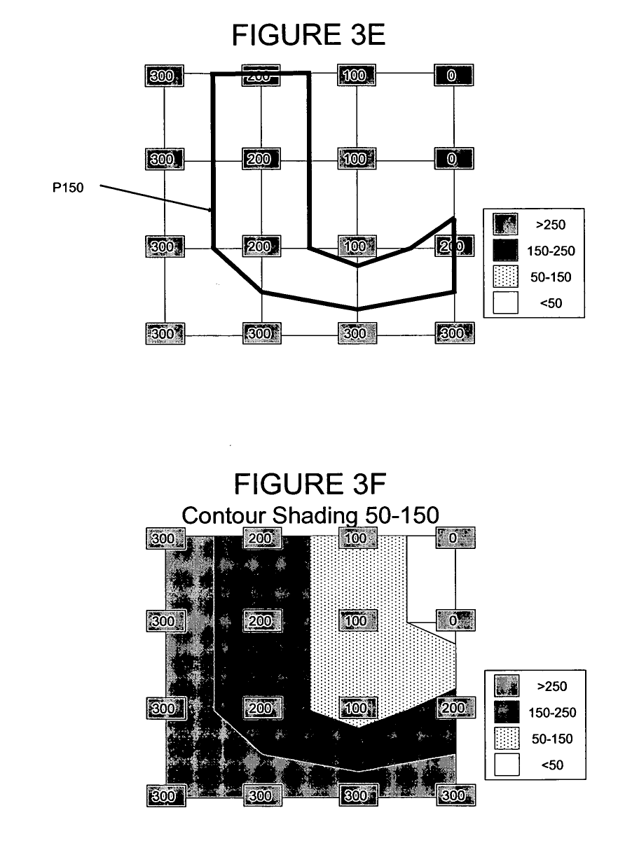

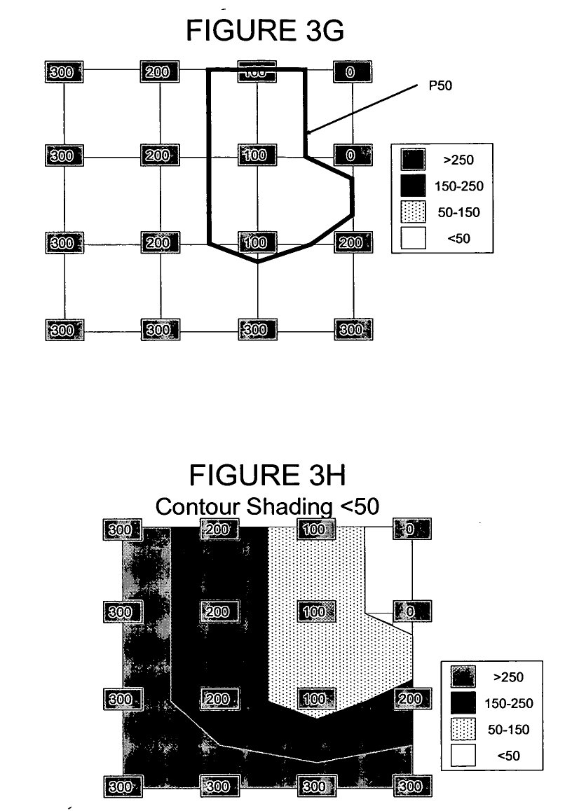

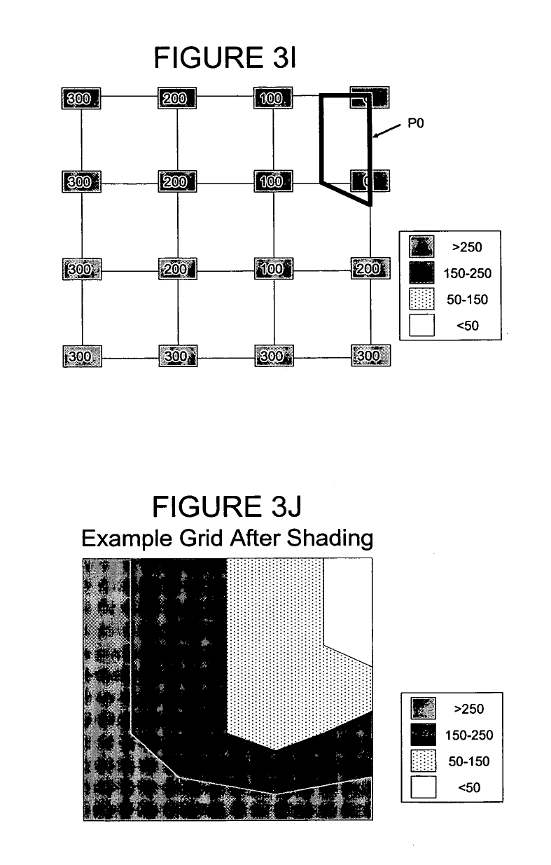

Once the contour lines are drawn, contour shading ranges may be used to graphically illustrate the change in contour levels. For example, in the example of FIG. 2A-2P, the contour shading ranges may be determined to be greater than 250, between 150 and 250, between 50 and 150, and less than 50. These ranges are illustrated in the scale of FIG. 3A.

The conventional approach to contour shading has been to find the complete perimeter of a contour region and creating a closed region from the contour lines and data set edges. Once the complete perimeter of a contour region is found any interior regions are removed, thereby forming a more topologically complex polygon. The topological polygons are then colored in, or additionally, the polygons are converted into triangle strips before scan conversion to facilitate the coloring-in process.

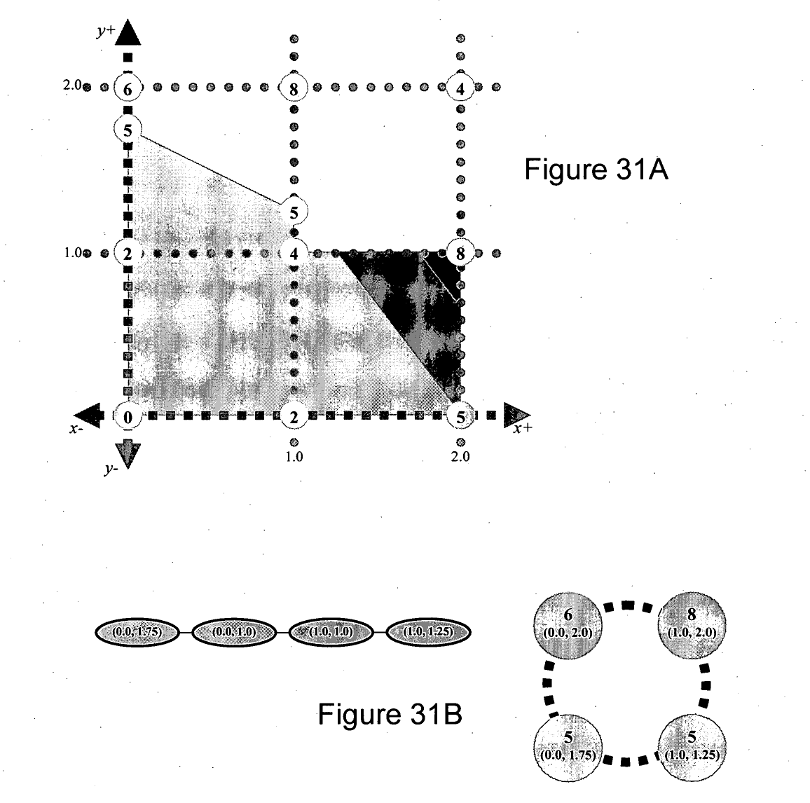

For example, in FIG. 3B, the points with contour values greater than 250 necessarily are found between the 250 contour line and the edges of the data set. In FIGS. 3A-3G, for brevity and to better illustrate the shading of the contour levels, individual grid cells A-I are not labeled. The labeling convention of FIGS. 2A-P is followed. The complete perimeter of the 250 contour line and the edge of the data set is a contour level>250. The complete perimeter P250 of the contour level>250 is highlighted in FIG. 3C. Similarly, as shown in FIG. 3D, the points with contour values between 150 and 250 lie between the 150 contour line, the 250 contour line, and the edges of the data set. The complete perimeter P150 of the 250<contour level<150 is highlighted in FIG. 3E. Likewise, as shown in FIG. 3F, the points with contour values between 50 and 150 lie between the 50 contour line, the 150 contour line, and the edges of the data set. The complete perimeter P50 of the 150<contour level<50 is highlighted in FIG. 3G. Last, as shown in FIG. 3H, the points with contour values between 0 and 50 lie between the 50 contour line and the edges of the data set. The complete perimeter P0 of the contour level<50 is highlighted in FIG. 31.

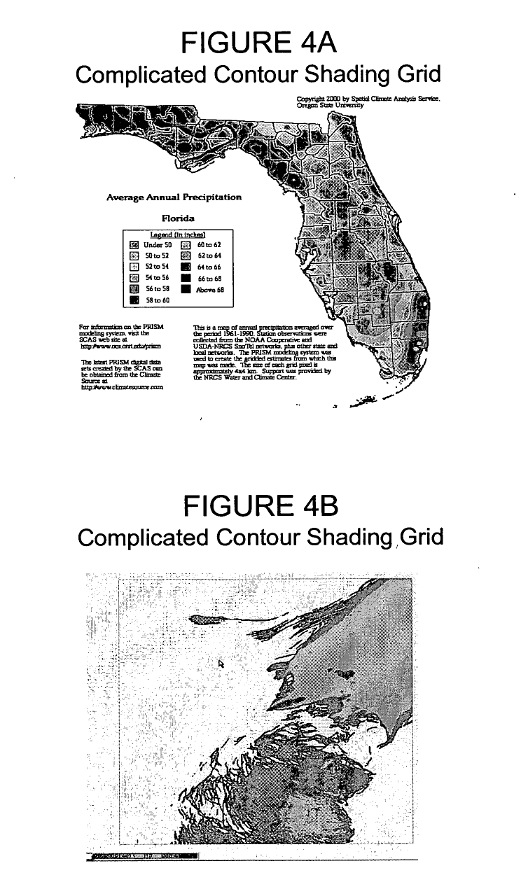

While easy for a human to discern visually, computers do not “think visually.” When determining the complete perimeter using the contour lines and data set edges with a computer, the ones and zeroes of the data set are obfuscated. For example, in FIG. 3C, the perimeter labeled P250 may be easily discerned. In FIG. 3E, the perimeter labeled P150 may be easily discerned, and in FIG. 3G, the perimeter labeled P50 may be easily discerned. Lastly, in FIG. 31, the perimeter labeled P0 is easily recognized. To a computer, after the contour line is traced, there is a list of many numbers, that is, the coordinates, and the contour level for that contour region. For complicated data sets such as those illustrated in FIGS. 4A and 4B, there may be hundreds or thousands of lists.

The system of the present invention draws contour regions piecewise by analyzing the collected information in one pass through the gridded data. The method of the present invention divides the gridded data into rectangular cells, or tiles, where each tile's corners are the sampled data from a particular cell in the gridded data. In the example to follow, each tile is analyzed for desired contour levels, working our way from “highest” to “lowest” contour level, creating and shading contour regions as we go. When the analysis is complete on a tile, the method of the present invention never has to revisit that tile, and the method proceeds on to the next tile.

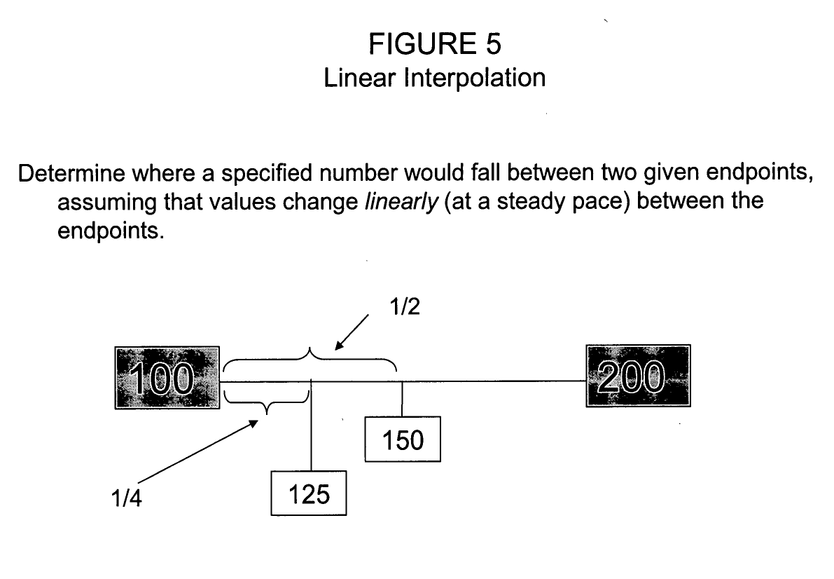

In order to efficiently perform this method, the system of the present invention works from two basic assumptions, namely that the “line” between any two orthogonally-neighboring grid points can be linearly interpolated so that, to generate new points on the “line”, a user needs only to use interpolation between the neighboring coordinates and between their corresponding sampled values. An example of this linear interpolation between two points is shown in FIG. 5. In FIG. 5, if the system of the present invention were to determine where a value of 150 would fall between block 100 and block 200, the 150 value would lie midway between the 100 block and the 200 block. Similarly, a value of 125 would lie one-quarter of the way from the 100 block to the 200 block, and so on.

The system of the present invention makes a second assumption and assumes that the gridded data represents the finest grain available. No further assumptions should be made about value trends/curvature within a tile (except in the case of data degeneracies, which is discussed later).

From these assumptions, it follows that no contour regions can be properly “interior” to a tile. In other words, each contour region in a tile must border at least one edge of the tile. This allows us to adopt a “convex hull” strategy for doing work on a tile.

The method of drawing and shading contour regions in the present invention is a mosaic style of shading. That is, for each tile (grid square), the system draws and colors all contour regions of interest. Once all the contour regions of interest are drawn and shaded for a particular tile, the method of the present invention moves to the next tile and processes the data for that tile. In fact, the contour lines-are created as the tile is shaded, as a by-product of the contour regions. The method of drawing and shading each tile is repeated until all tiles are processed. Once all tiles are processed, the method is complete. There is no need to return to the tiles for a second pass. The processed tiles comprise smaller contour regions. These smaller contour regions are “glued together” mathematically to form larger contour regions of any shape or size, with no gaps in the regions.

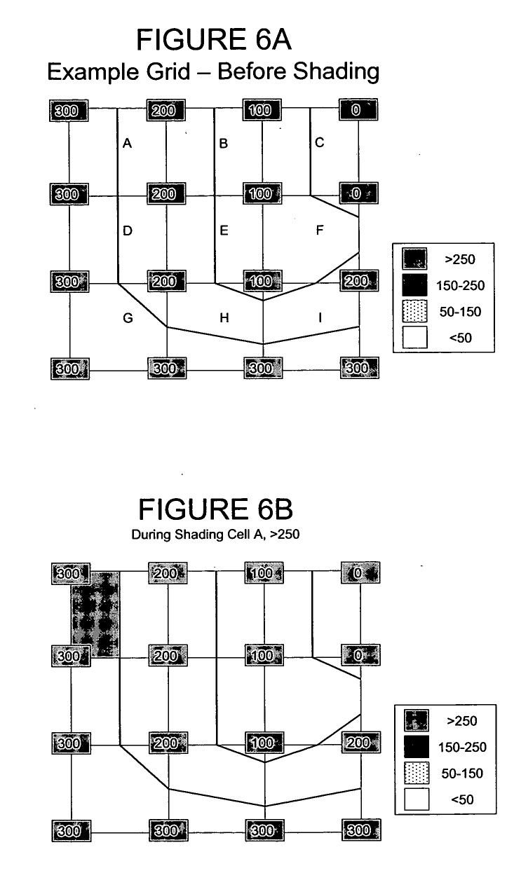

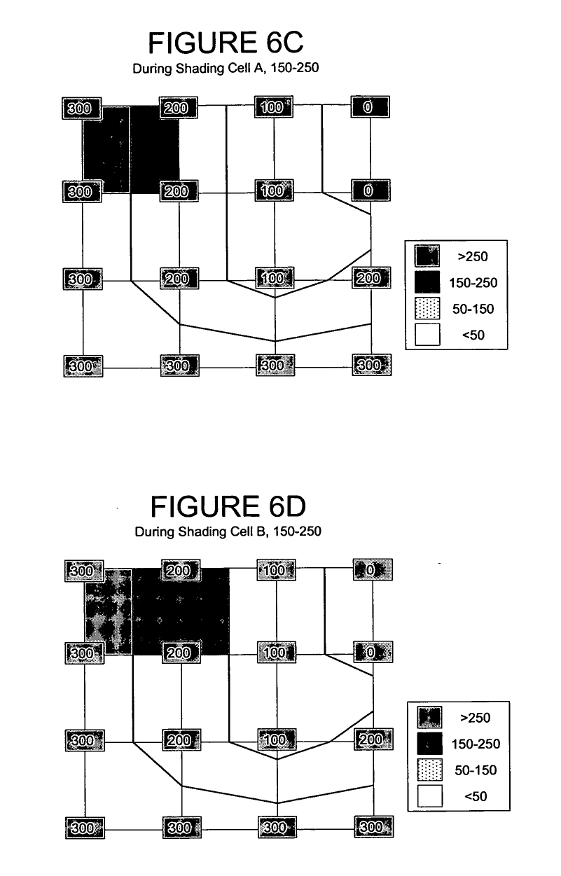

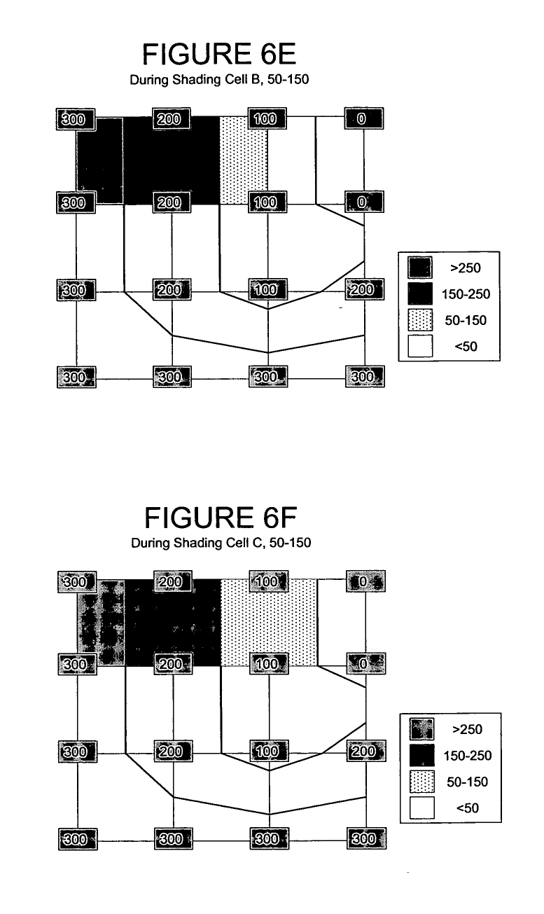

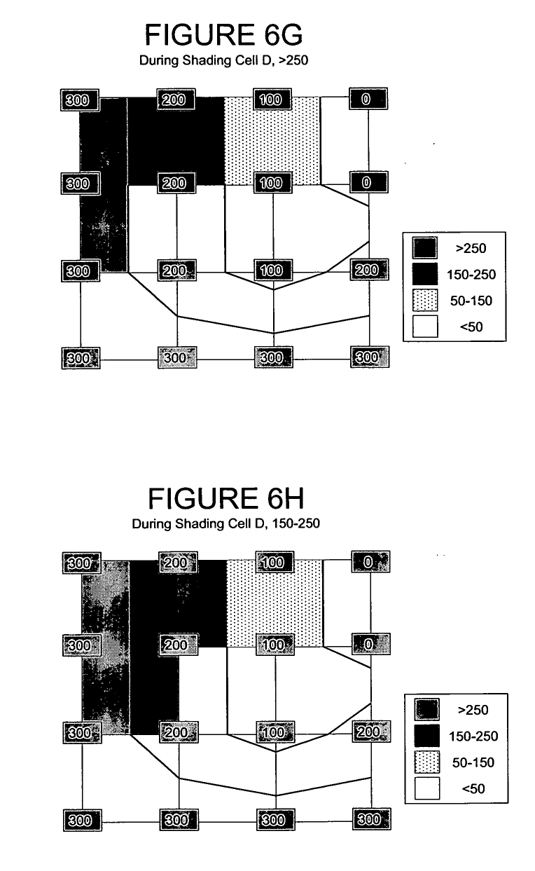

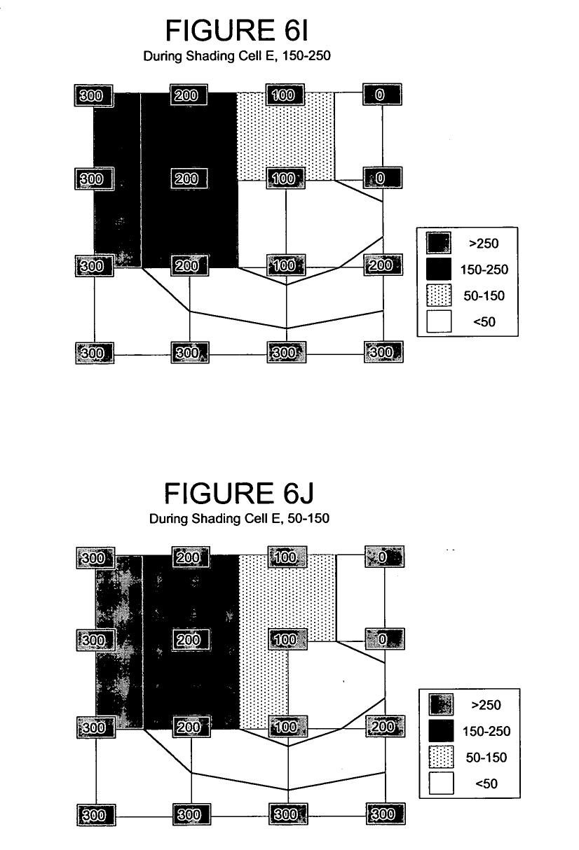

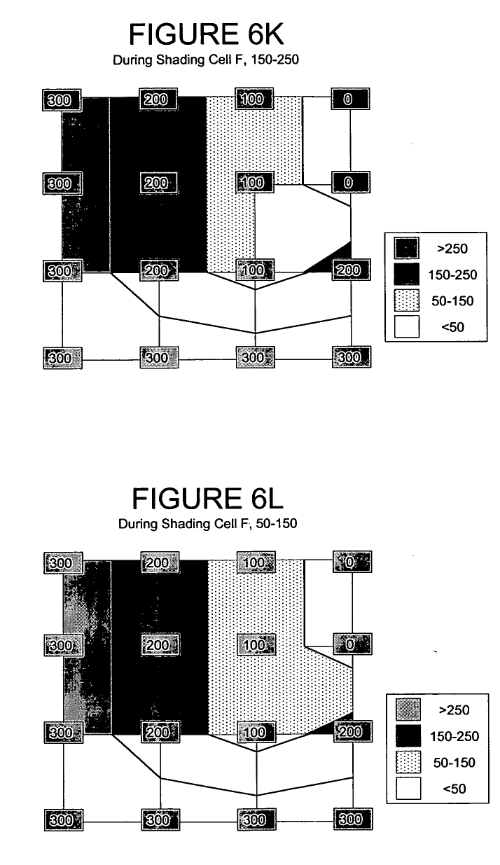

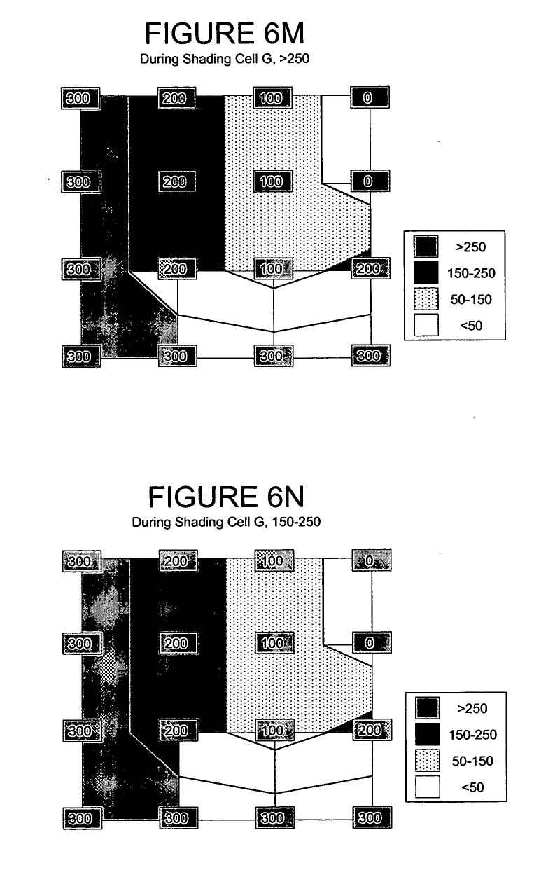

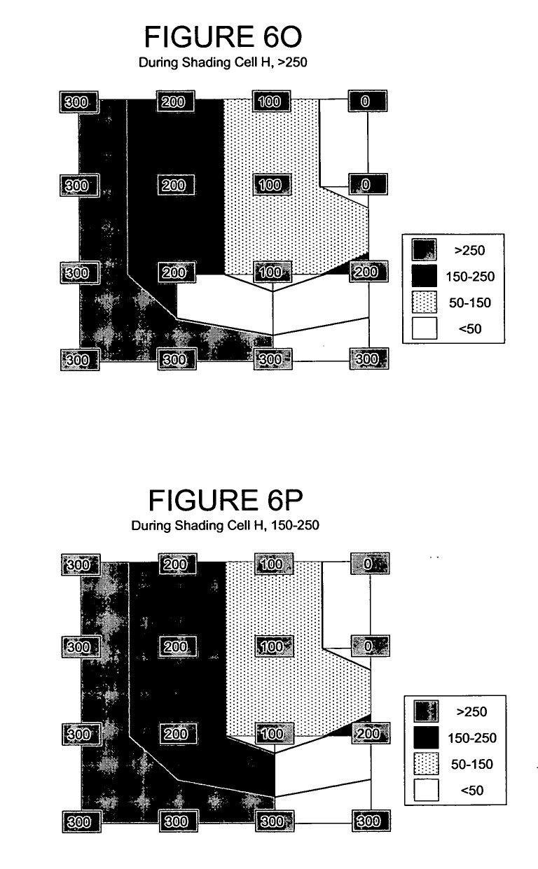

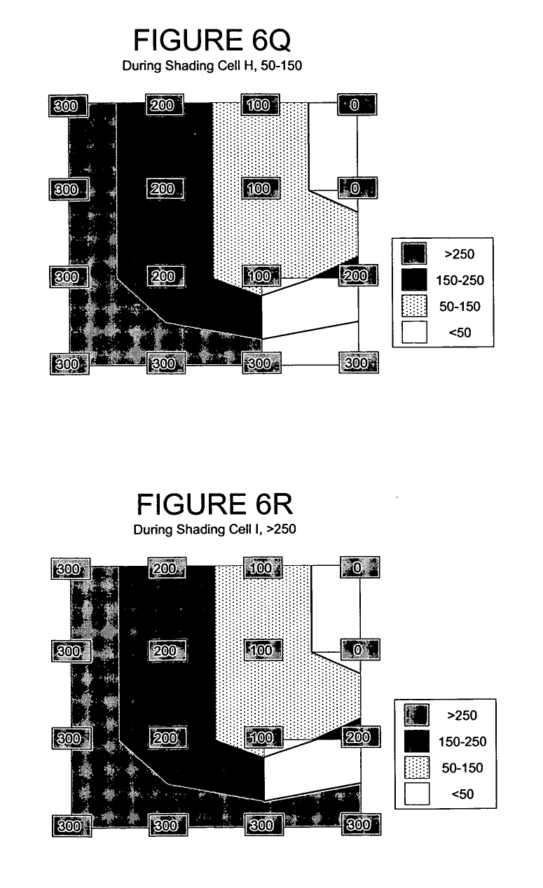

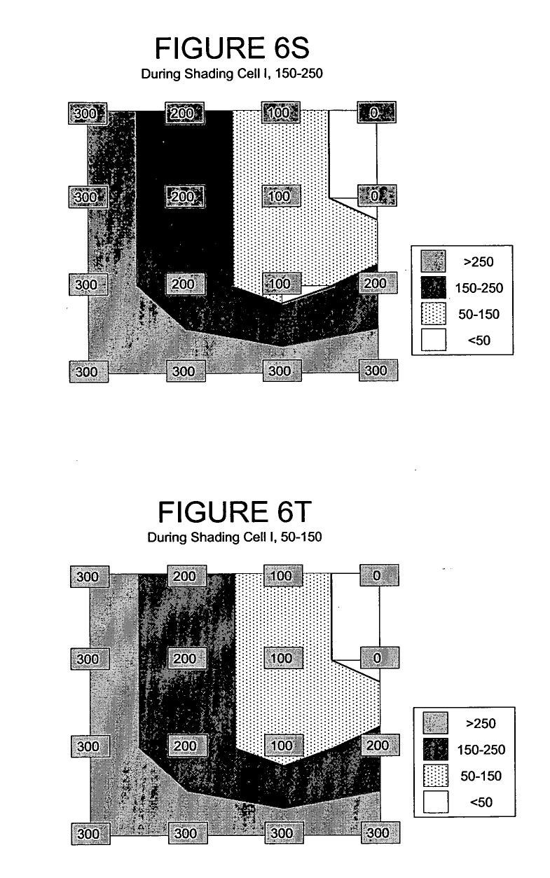

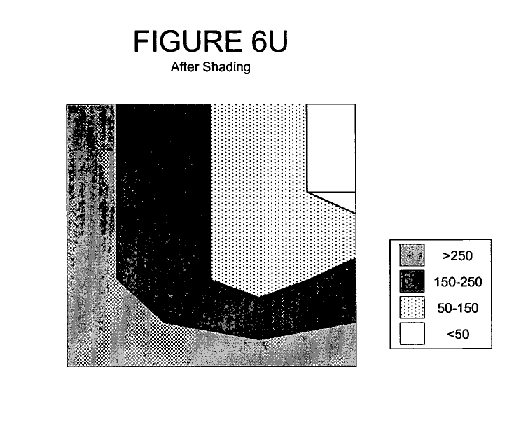

As shown beginning in FIG. 6A, the same example grid used to illustrate the conventional manner of drawing and shading contour regions is utilized again to illustrate the method of drawing and shading contour regions of the present invention.

In the following example, the contour regions are shaded from highest contour value to lowest, but any order may be chosen depending upon the expected grid data and the individual application. In FIG. 6B, the first cell A is analyzed and contour values greater than 250 are shaded. Next, in FIG. 6C, instead of moving to the next cell to follow the contour line, the method of the present invention evaluates and shades the next set of contour values in cell A. That is, the method of the present invention analyzes and shades values between 150 and 250 in cell A. Analysis and shading of cell A is now complete because there are no additional points within the cell that have not been shaded. The shading method moves on to cell B.

In FIG. 6D, the second cell B is analyzed. Because there are no contour values greater than 250, no shading of the>250 values are performed. Instead, in FIG. 6D the method shades those values between 150 and 250. Similarly, in FIG. 6E, instead of moving to the next cell to follow the contour line, the method of the present invention evaluates and shades the next set of contour values in cell B. That is, the method of the present invention analyzes and shades values between 50-150 in cell B. Analysis and shading of cell B is now complete because there are no additional points within the cell that have not been shaded. The shading method moves on to cell C.

In FIG. 6F, the third cell C is analyzed. There are no points within cell C with values greater than 250. Similarly, there are no points within cell C with values between 150 and 250, so the method of the present invention shades the contour values between 50-150 in cell C. Analysis and shading of cell C is now complete because there are no additional points within the cell that have not been shaded. The shading method moves on to cell D.

In FIG. 6G, cell D is analyzed and contour values greater than 250 are shaded. Next, in FIG. 6H, instead of moving to the next cell to follow the contour line, the method of the present invention evaluates and shades the next set of contour values in cell D. That is, the method of the present invention analyzes and shades values between 150 and 250 in cell A. Analysis and shading of cell D is now complete because there are no additional points within the cell that have not been shaded. The shading method moves on to cell E.

In FIG. 6I, cell E is analyzed. Because there are no contour values greater than 250, no shading of the>250 values are performed. Instead, in FIG. 6I the method shades those values between 150 and 250. Similarly, in FIG. 6J, instead of moving to the next cell to follow the contour line, the method of the present invention evaluates and shades the next set of contour values in cell E. That is, the method of the present invention analyzes and shades values between 50-150 in cell E. Analysis and shading of cell E is now complete because there are no additional points within the cell that have not been shaded. The shading method moves on to cell F.

In FIG. 6K, cell F is analyzed and contour values between 150 and 250 are shaded. In this example, even though the contour values between 150 and 250 are “disconnected” from the “just-followed” contour lines of cell E, the method of the present invention analyzes and shades those contour values in cell F from highest to lowest. As shown in FIG. 6L, once the contour values between 150 and 250 are shaded in cell F, the method of the present invention evaluates and shades the next set of contour values in cell F. That is, the method of the present invention analyzes and shades values between 50 and 150 in cell F. Analysis and shading of cell F is now complete because there are no additional points within the cell that have not been shaded. The shading method moves on to cell G.

In FIG. 6M, cell G is analyzed and contour values greater than 250 are shaded. Next, in FIG. 6N, instead of moving to the next cell to follow the contour line, the method of the present invention evaluates and shades the next set of contour values in cell G. That is, the method of the present invention analyzes and shades values between 150 and 250 in cell G. Analysis and shading of cell G is now complete because there are no additional points within the cell that have not been shaded. The shading method moves on to cell H.

In FIG. 6O, cell H is analyzed and contour values greater than 250 are shaded. Next, in FIG. 6P, the method of the present invention evaluates and shades the next set of contour values in cell H. That is, the method of the present invention analyzes and shades values between 150 and 250 in cell H. Next, in FIG. 6Q, the method of the present invention analyzes and shades values between 50 and 150. Analysis and shading of cell H is now complete because there are no additional points within the cell that have not been shaded. The shading method moves on to cell I.

In FIG. 6R, cell I is analyzed and contour values greater than 250 are shaded. Next, in FIG. 6S, the method of the present invention evaluates and shades the next set of contour values in cell I. That is, the method of the present invention analyzes and shades values between 150 and 250 in cell I. Next, in FIG. 6T, the method of the present invention analyzes and shades values between 50 and 150. Analysis and shading of cell I is now complete because there are no additional points within the cell that have not been shaded. The shading method is complete because all cells have been analyzed and shaded from the highest contour values to the lowest, and there are no additional cells to analyze. The completed shaded grid data is shown in FIG. 6U.

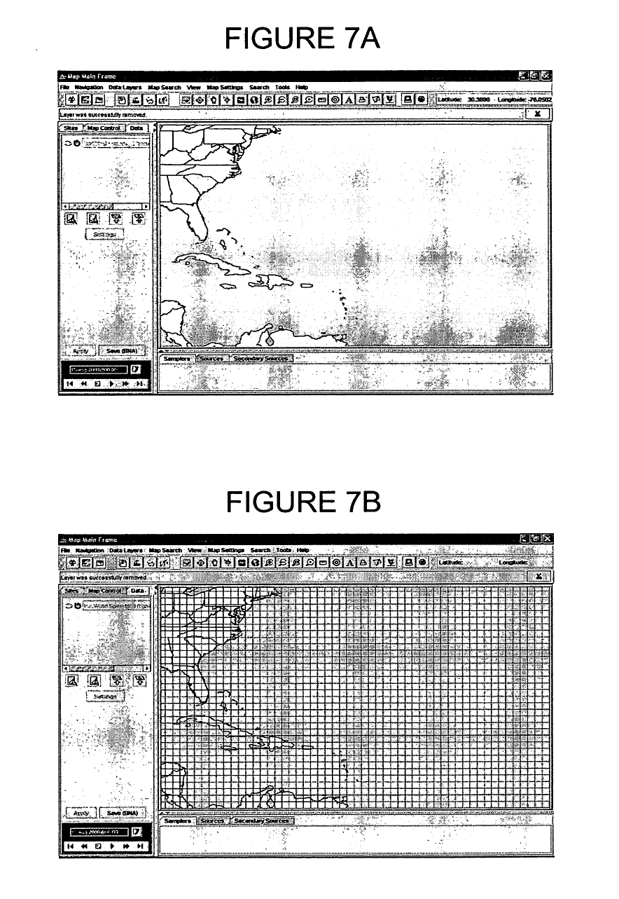

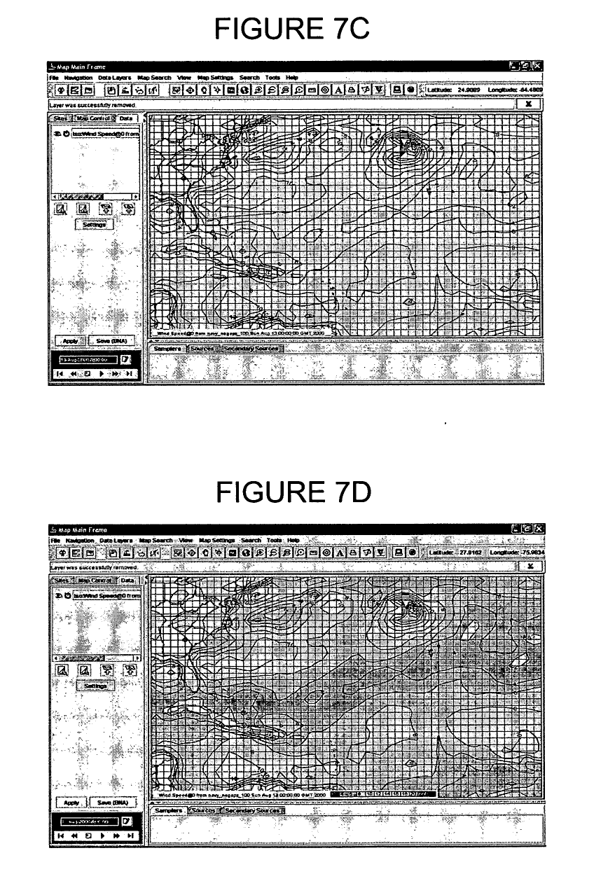

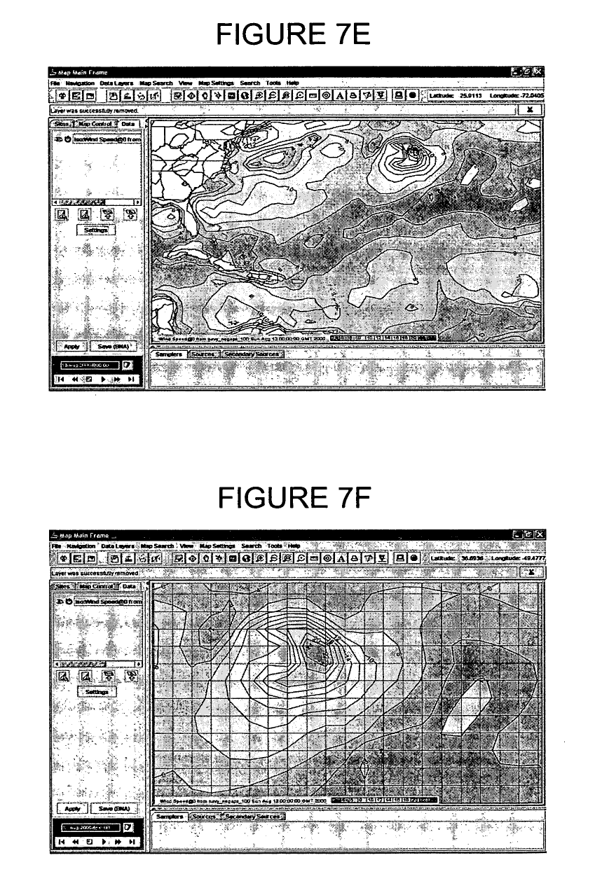

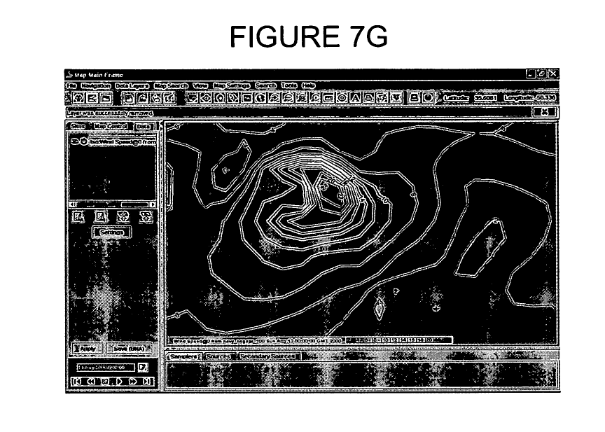

The results of the method of the present invention may be used to produce a shaded contour grid two orders of magnitude faster than conventional methods. The additional examples shown in FIGS. 7A-7G illustrate complicated data sets analyzed and shaded by the system and method of the present invention.

FIG. 7A shows the southeast coast of the United States and the Caribbean region. The system and method of the present invention produces a contoured map illustrating wind speeds for this region. In FIG. 7B, the map is divided into tiles. In FIG. 7C, contour lines are drawn showing twelve contour levels of 0 to 24 knots (in increments of two knots). In FIG. 7D, the system and method shade the twelve contour regions proceeding from tile to tile until all grid cells have been shaded. In FIG. 7E, the grid is removed to display the resulting contour map.

FIG. 7F shows a close-up view of a section of the contour map, while FIG. 7G illustrates the same section with the grid lines removed.

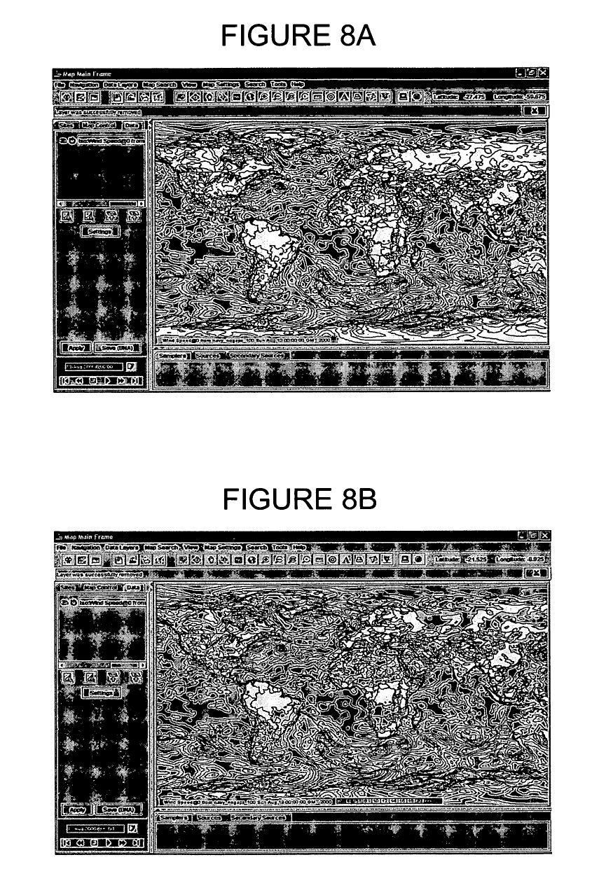

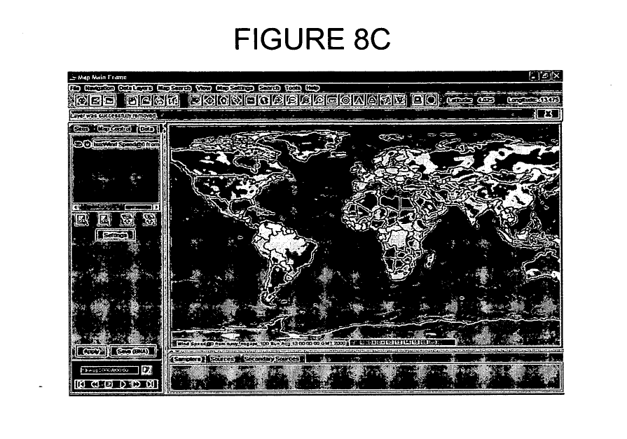

FIGS. 8A-8C illustrate an even more complex data set, where wind speeds around the world are evaluated and mapped. FIG. 8A shows contour lines drawn illustrating twelve contour levels of 0 to 24 knots (in increments of two knots). In FIG. 8B, the system and method shade the twelve contour regions proceeding from tile to tile until all grid cells have been shaded. In FIG. 8C, the grid is removed to display the resulting contour map. The system and method of the present invention took the 360 degree (longitude) and 180 degree (latitude) by 12 levels (the contour levels) and produced the contour map of FIG. 8C. When using a conventional contouring technique, the program proceeded for seventy minutes before giving up without a complete and correct result. In contrast, the method of the present invention completely and correctly produced the contour map in fourteen seconds. Similar results have been observed on equally complex data sets. Additionally, the method and system of the present invention may be extended to three-dimensional data sets as well. Parallel processing techniques may be implemented to realize improved speeds.

Degeneracy-Handling

Historically, two types of data set situations cause ambiguity and difficulty for contouring algorithms and data interpretation. These types of data sets are referred to as “pathological” or “degenerate” data. A contouring strategy must be adept at handling these types of data sets. A contouring method of the present invention has an effective and defensible strategy for handling these degeneracy situations. The system and method of the present invention gives predictable, consistent results when facing degenerate data sets and thereby provides robust and improved results over conventional contouring techniques.

Corner Contour Level

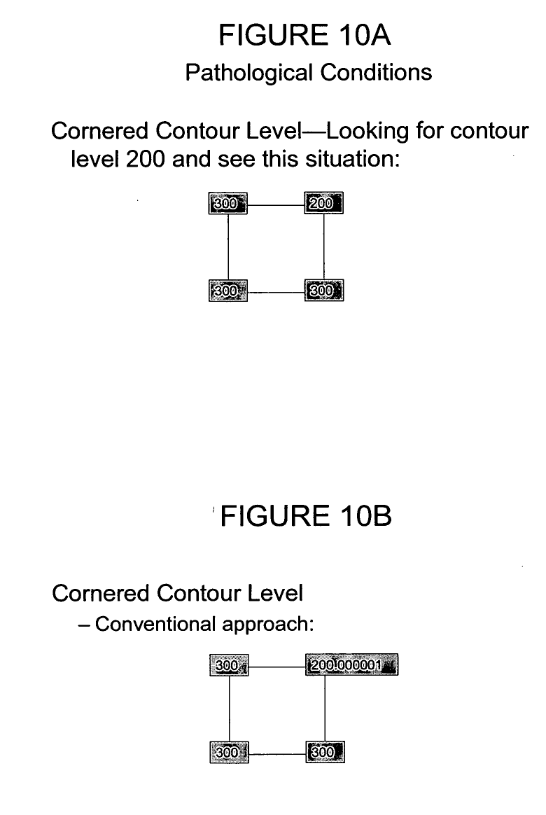

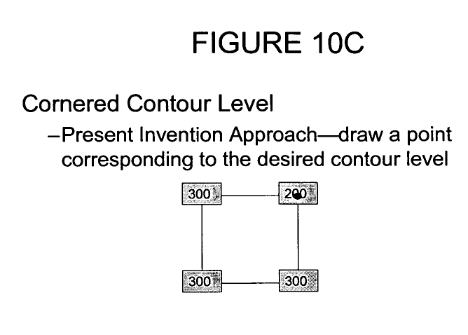

The first degeneracy situation occurs when a desired contouring level occurs at a sampling point. That is, the desired contour level coincides with a corner of a data tile. This example is shown starting in FIG. 10A. In this example, the case of a cornered contour level causes difficulties in analysis, processing, and mapping in conventional contouring systems. A cornered contour level is difficult for conventional contouring systems to resolve. FIG. 10A shows a single tile with a contour level of 200 that is one of the contour levels to be mapped. As shown in FIG. 10B, if a conventional system is attempting to map a contour level of 200 and encounters this tile, conventional systems incrementally add to this corner point to evade the contour level to be mapped. That is, the 200 data point becomes a value of 200.000001 and the conventional system is then able to draw the contour line. This method of dealing with pathological cornered contour levels requires tremendous computing resources and time to perform the additional analysis.

The system and method of the present invention merely draws the appropriate contour point (using existing points) along the perimeter of the data set that match the contour level being processed as shown in FIG. 10C. This approach conserves computing resources and results in a much faster and more robust handling of this pathological data case. Similarly, the system and method of the present invention may also create new data points (through interpolation) that match the desired contour level.

Ambiguous Path

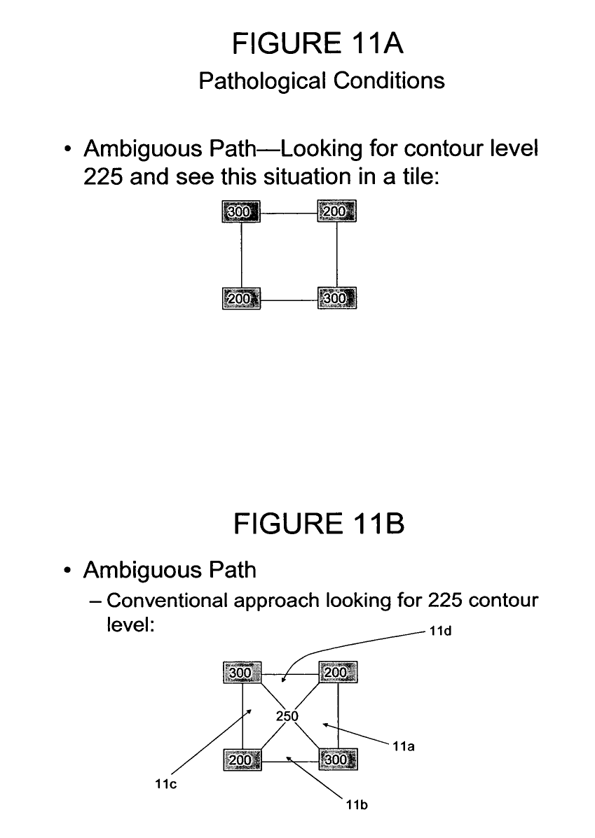

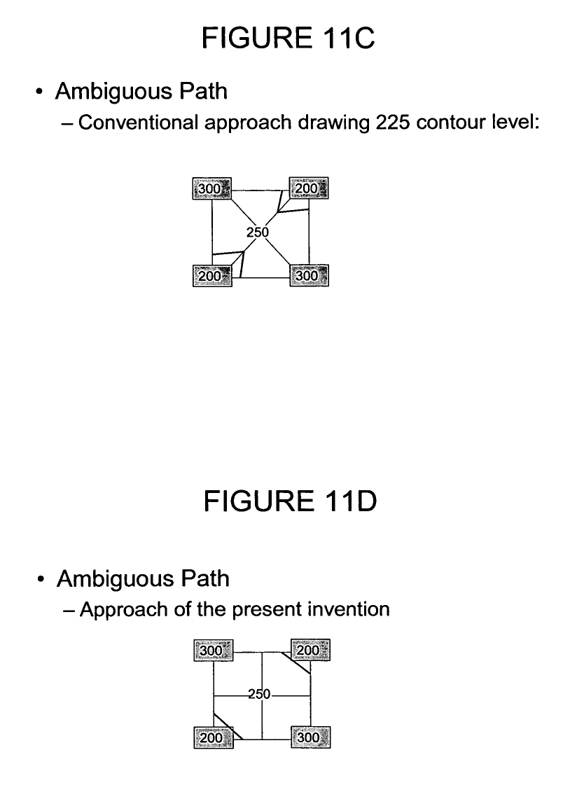

The ambiguous path is a second data degeneracy situation is problematic for conventional contouring methods. The ambiguous path occurs when the value of a contour level is less than the minimum sampled value of two opposing corners of a tile but exceeds the maximum sampled value of the other two opposing corners of that tile. An ambiguous path contour level is difficult for conventional contouring systems to analyze, process, and map. FIG. 11A shows a single tile with corner points having values of 200, 300, 200, and 300, respectively, and the system is attempting to draw a contour level of 225. This results in the chosen contour level having interpolated values on all four perimeter edges of the starting tile. Conventional systems have difficulty connecting these edges together to make contour lines and regions.

Historically, there have been several approaches to this problem. The conventional dominant practice is to subtile degenerate tiles via “triangulation.” The approach creates triangles by drawing lines between data points. The original data points are connected in such a way that no triangle edges are intersected by other triangles. The result is a patchwork of triangular faces over the extent of the grid. Each triangle defines a contour level of data points lying within the triangle, with the new subtile data points of the triangle determined by the original data points.

For example, in FIG. 11B, conventional contouring systems may compute the average of the four corner values ((200+300+200+300)÷4) and place this value (250) in the middle of the tile (with center coordinates equal to the averages of the latitudes and longitudes of the corners). Conventional systems may then draw lines from this middle point to each corner, thus forming four triangular subtiles 11a, 11b, 11c, 11d. Each of these triangular tiles is mathematically guaranteed to be nondegenerate. The next step in the conventional manner of handling this type of data degeneracy is to treat these four subtiles as tiles to be contoured as shown in FIG. 11C. A common practice is to triangulate all tiles, regardless of their degeneracy status, and not spend time checking each tile and subtiling only as needed.

In contrast, the system and method of the present invention merely interpolates along the perimeter of the data set and draws the appropriate contour lines along the perimeter as shown in FIGURE 11D. This approach conserves computing resources and results in a much faster and more robust handling of this pathological data case.

In fact, the system and method of the present invention may also be used to compute degenerate cases using triangulation techniques, because it actually can deal with tiles of any convex polygonal shape. However, when employing triangulation methods, there are necessary assumptions and results of triangulation that introduce unsatisfactory aspects into the data set. For example, triangulation introduces linearities into the center of the tiles, where none existed before, and this is done merely to deal with a computational ambiguity. Additionally, these introduced linearities cause skewed interpolations and unnecessarily bent contour lines. With the system and method of the present invention, such unsatisfactory characteristics are not introduced into the data set. The system and method of the present invention provides improved speed and accuracy in dealing with pathological data over conventional contour techniques.

Exemplary System Configuration

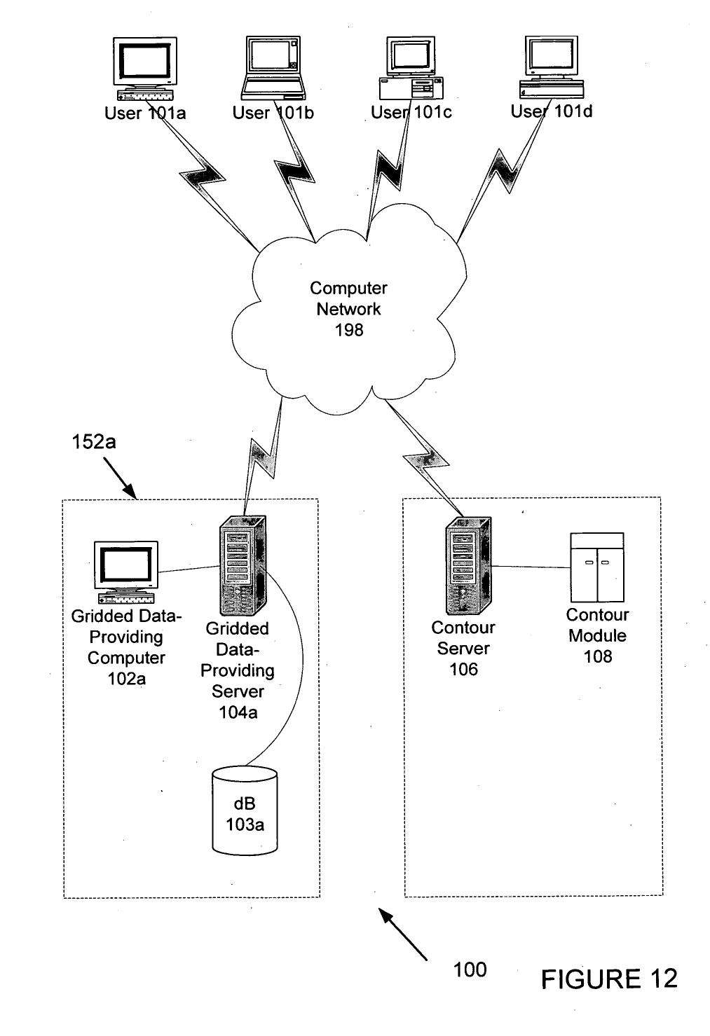

FIG. 12 illustrates an exemplary computer system in which concepts and methods consistent with the present invention may be performed. As shown in FIG. 12, system 100 comprises a number of users 101a, 101b, 101c, 101d that may receive a gridded data set, such as that provided by gridded data providing computer 102a and gridded data providing server 104a with which to access a database 103a of gridded data. For clarity and brevity, four users 101a, 101b, 101c, 101d are shown, but it should be understood that any number of users may use the system 100 with which to access gridded data in a database 103a. Database 103a may also be a network of databases as well. Likewise, it should also be understood that any number of gridded data providing nodes may be used by the system. For clarity and brevity, a single gridded data providing node 152a comprising a gridded data providing computer 102a, a gridded data providing server 104a, and a database 103a is shown. It should also be understood that users 101a, 101b, 101c, 101d and gridded data providing node 152a may be substituted for one another. That is any user 101a, 101b, 101c, 101d may access gridded data housed and stored by another user. Gridded data node 152a is illustrated as components 102a, 103a, 104a merely to show a preferred embodiment and a preferred configuration. The gridded data collection can be in a distributed environment, such as servers on the world wide web.

Users 101a, 101b, 101c, 101d may access gridded data providing node 152athrough any computer network 198 including the Internet, telecommunications networks in any suitable form, local area networks, wide area networks, wireless communications networks, cellular communications networks, G3 communications networks, Public Switched Telephone Networks (PSTNs), Packet Data Networks (PDNs), intranets, or any combination of these networks or any group of two or more computers linked together with the ability to communicate with each other.

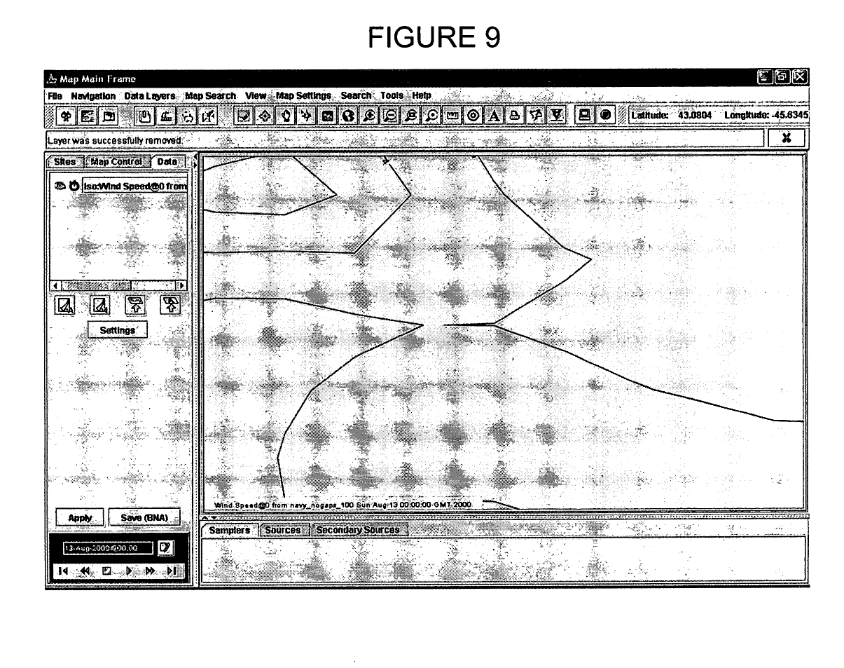

As illustrated in FIG. 12, computer network 198 may be the Internet where users 101a, 101b, 101c, 101d are nodes on the network as is gridded data providing node 152a. Users 101a, 101b, 101c, 101d and gridded data providing node 152a may be any suitable device capable of providing gridded data to another device. For example these devices may be any suitable servers, workstations, PCs, laptop computers, PDAs, Internet appliances, handheld devices, cellular telephones, wireless devices, other devices, and the like, capable of performing the processes of the exemplary embodiments of FIGS. 1-50. The devices and subsystems of the exemplary embodiments of FIGS. 1-50 can communicate with each other using any suitable protocol and can be implemented using one or more programmed computer systems or devices. In general, these devices may be any type of computing platform connected to a network and interacting with application programs.

Gridded data server 106 is also a node on computer network 198. Gridded data server 106 utilizes a contour module 108. Gridded data server 106 may also be any suitable device capable of using contour module 108 to perform the contour shading of sampled data using relevant information and data sets from gridded data providing nodes 152a in response to search queries from users 101a, 101b, 101c, 101d.

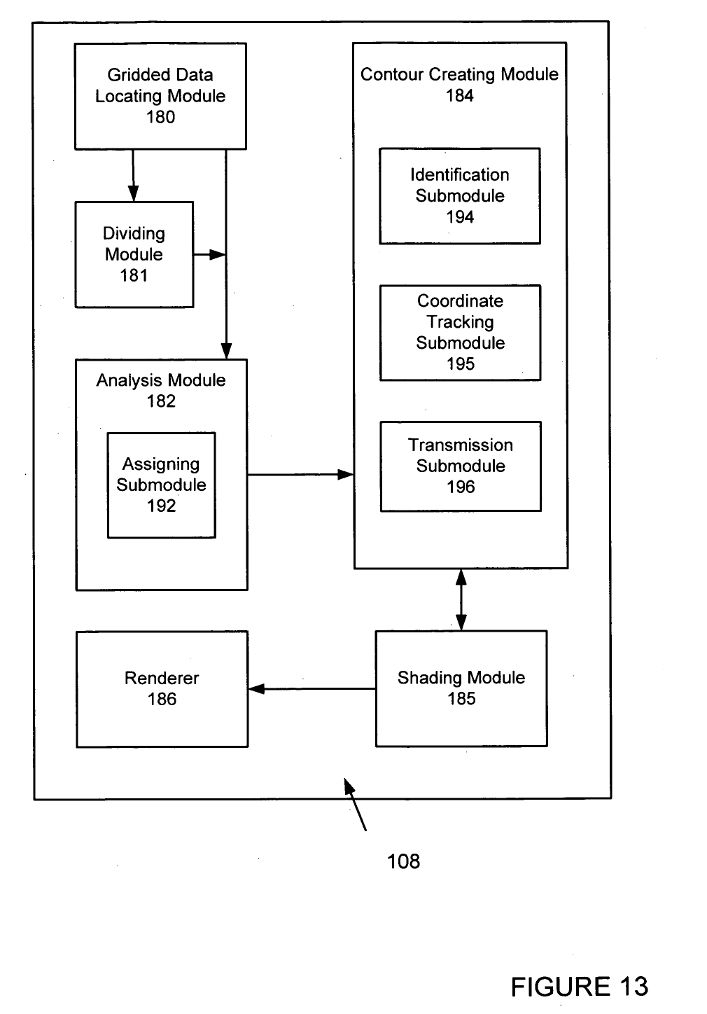

While discussed in greater detail with regard to FIG. 13, contour module 108 receives gridded data in response to requests from users 101a, 101b, 101c, 101d. Users 101a, 101b, 101c, 101d send requests to contour server 106 via computer network 198. Contour server 106 uses contour module 108 to access the gridded data, and contour module 108 displays a list of relevant sets of gridded data to the users 101a, 101b, 101c, 101d. In a preferred embodiment, users 101a, 101b, 101c, 101d submit requests to the contour server 106 to locate gridded data in which the 101a, 101b, 101c, 101d are interested. These gridded data sets are normally stored at gridded data nodes 152a, other users 101a, 101b, 101c, 101d, or other devices, systems, or nodes connected to computer network 198.

As illustrated in FIG. 13, contour module 108 includes gridded data locating module 180, dividing module 181, analysis module 182, contour creating module 184, shading module 185, and renderer 186. Gridded data locating module 180 receives a set of gridded data, whose contents match a user request. Dividing module 181 divides the set of gridded data into tiles. The tiles may be rectangular cells, for example, or other geometric shapes that facilitate processing the data set. Additionally, the size of the selected cell may vary depending upon the type and size of the gridded data set. The gridded data can be chosen to represent the finest grain available, that is, the data of the highest resolution. Further, depending upon the selected geometric shape of the cell, the tiles may include corner points using sampled data from the set of gridded data.

Once the dividing module 181 divides the set of gridded data into tiles, the analysis module 182 analyzes each tile sequentially to determine contour levels within each tile from lowest contour level to highest contour level. The analysis module 182 may employ an assigning submodule 192 to assist in performing the sequential analysis by assigning a circular list of coordinates representing the outer perimeter of a tile. The sequential analysis may also be performed by other suitable means capable of analyzing each tile in order as well. The circular list of coordinates may then be used by identification sub module 194 in contour creating module 184 to identify polygonal bounds of the contour region under analysis. The analysis may proceed step-wise or sequentially through the tiles using coordinate tracking submodule 195 to track the used and unused coordinates.

The contour creating module 184 uses the identified bounds and creates a contour region based upon the determined contour levels. The contour creating module 184 then sends the identified contour region or identified polygon bounds to a renderer 186 for providing the contoured region for display. Additionally, a shading module 185 may receive the identified polygon bounds or identified contour region and shade the contour region prior to passing the region to the renderer 186.

With this configuration, contour module 108 is extremely flexible and responsive to a particular user's needs. For example, a variety of gridded data sets may be used in conjunction with various contour regions to render different types of maps. For example, a topographic map may be illustrated with contour lines connecting two points with similar physical characteristics, such as elevation, temperature, humidity, and the like.

Circular Coordinates

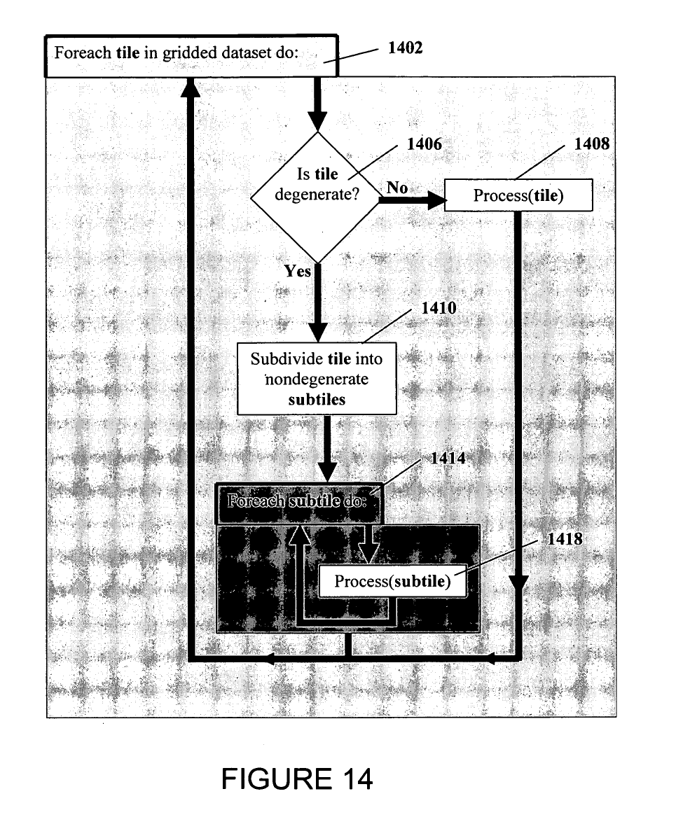

The functionality of contour module 108 is described further below with reference to FIGS. 14-50.

For each tile, the system 100 maintains a circular list of coordinates that represent the outer perimeter of the “contourable area” that is being partitioned into contour regions. The system and method works sequentially through the contour levels, from largest to smallest (or alternatively smallest to largest), “chipping off” contour regions from the contourable area as the process progresses. The “chipping off” occurs as the system identifies the polygonal bounds of each contour region. The identified polygon is sent to the renderer and the circular list is adjusted to remove those coordinates that made up the region. In that way, the contourable area shrinks as the method progresses through the contour levels for the tile. For each tile, the process stops once all contour levels are processed, or if the contourable area is exhausted.

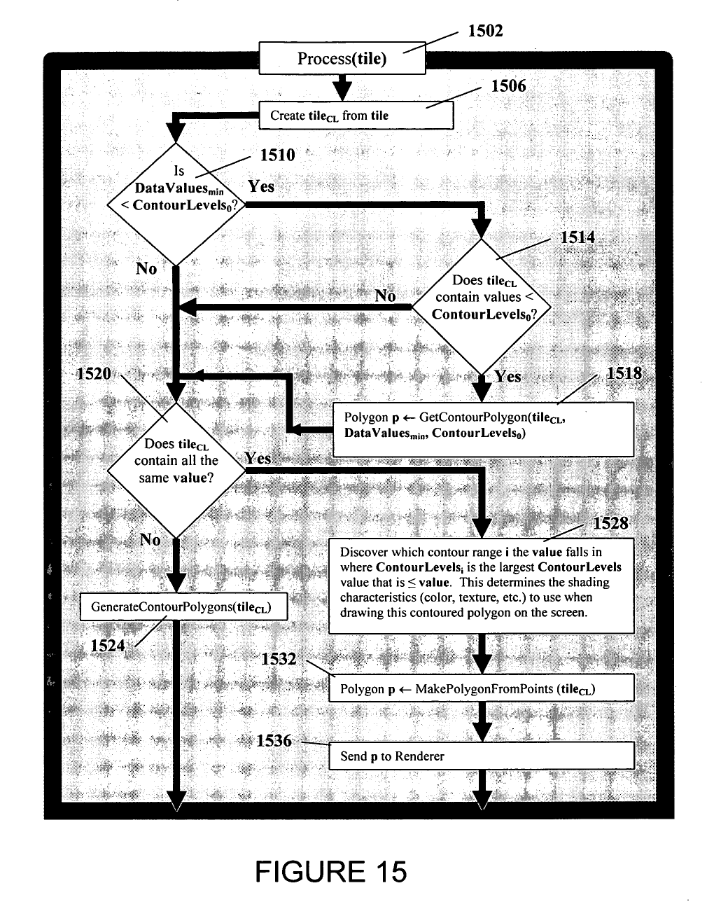

FIG. 14 shows a process that iterates through all tiles in the gridded data set. As shown in FIG. 14, for each tile in a gridded data set, the system and method of the present invention starts in step 1402 by choosing the next tile for processing. The tiles may be chosen systematically or at random. In one embodiment of the present invention, the tiles are processed row-by-row, and column-by-column within each row, although other selection schemes may also be used depending upon the application in which the system and method of the present invention is employed. The system and method of the present invention determines if the tile is degenerate in step 1406. If the tile is not degenerate, the tile is processed in step 1408. The tile processing substeps of step 1408 are described further below with reference to FIG. 15. If the system and method of the present invention determines that the tile is degenerate in step 1406, the tile is subdivided into non-degenerate subtiles in step 1410. In step 1414, as was the case with step 1402, the system and method iterates through a collection of tiles, though in the case of step 1414, the collection is of subtiles resulting from a subdivision strategy to divide the tile into non-degenerate subtiles. In step 1414, the system and method recognizes each subdivided non-degenerate subtile, and in step 1418, each subtile is processed to generate all contour regions for the subtile using the same method outlined with regard to the processing of tiles in FIG. 15. Once each subtile is processed in step 1418, the process returns to step 1402, and the next tile in the gridded database is evaluated and processed.

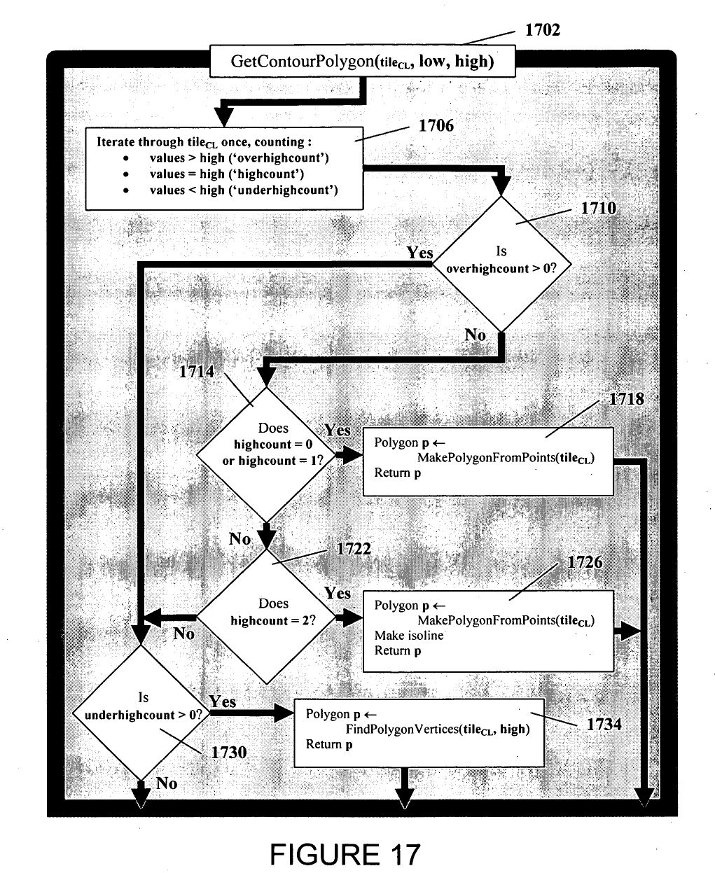

FIG. 15 illustrates the manner in which a tile is processed. This routine employs a list of n ContourLevels (indexed/subscripted 0 to n−1) and the minimum and maximum of all gridded data values (DataValuesₘᵢₙ and DataValuesₘₐₓ, respectively) are known via earlier data collection and processing. The processing of the tile data begins in step 1502. In step 1506, a circular list, tile_{CL}, is created from the tile data. This circular list is doubly-linked and has nodes, which each represent the data value and x-y coordinates for a tile vertex. In step 1510, the system and method of the present invention determines if there is gridded data values that are less than the lowest contour level value. If this condition exists, the system and method of the present invention goes to step 1514 and checks to see if the tile has one or more of these “low” values. If the tile has one or more of these low values, then the system and method of the present invention creates a polygon out of these values (using the steps illustrated in FIG. 17). However, the system does not draw this polygon, since it was not meant to be seen. However, the values are removed from tile_{CL} and the process continues.

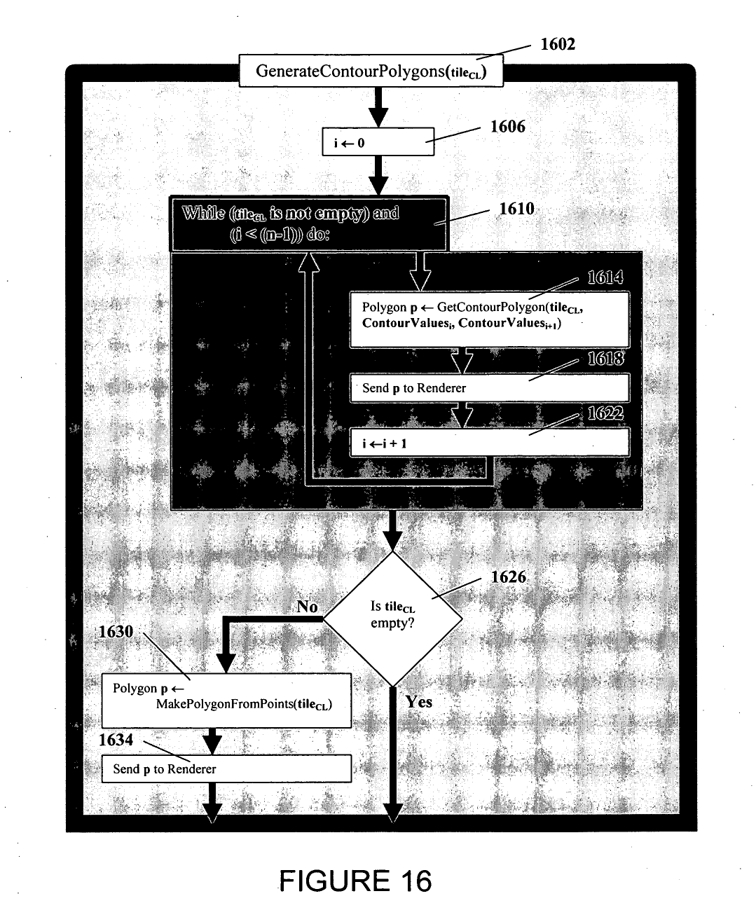

In step 1520, the system and method of the present invention checks to see if all of tile_{CL}'s values are the same because this situation often happens in practice with physical data. If all of tile_{CL}'s values are the same, the method progresses to step 1528. In step 1528, the system and method of the present invention searches through the contour levels to find the contour level that this repeated value falls within. The search may be performed in any number of ways, including linear searches through the data set resulting in good results since the list of contour levels is typically not long. However, if the repeated value is greater than or equal to the maximum contour level, the system and method of the present invention determines that this range is also visibly contoured. In step 1532, the system and method of the present invention creates the polygon from tile_{CL} and in step 1536, the system sends this polygon on to the renderer. If, however, tile_{CL} contains varying values, then control passes to step 1524 (see FIG. 16) for further processing.

FIG. 16 illustrates at a high level how the system and method of the present invention extracts and draws contour polygons out of nondegenerate tiles. The process begins in step 1602, and in step 1606 the contour level index (i) is set to the lowest level. In step 1610, a subroutine iterates through all contour levels, starting with the lowest. The subroutine runs until either tile_{CL} is empty (meaning that all contour polygons have been found and processed in the current tile) or until the very last level is about to be processed.

The subroutine includes three steps. In step 1614, the system and method of the present invention extracts the contour polygon for the current contour level (ContourValueᵢ to ContourValueᵢ₊₁). See also FIG. 17. In step 1618, this contour polygon is drawn, and in step 1622, the contour level index is incremented to the next level.

Once the process exits the subroutine, in step 1626, the system and method of the present invention determines if the tile was completely processed (tile_{CL} is empty) or if the highest contour level remains to be processed. If the tile was completely processed, the system and method of the present invention simply exits the process. If the highest contour level remains to be processed, control passes to step 1630, where the remaining elements of tile_{CL}, which must all be ≧ContourValueₙ₋₁, are put into a polygon, which is then rendered in step 1634. After completing step 1634, the process is complete.

FIG. 17 illustrates a number of special cases that often must be dealt with before possibly extracting a contour polygon from tile_{CL}. In step 1702, the system and method of the present invention begins operation, with the assumption that all values in tile_{CL} are≧low. The goal is to return the contour polygon containing values fitting the condition low≦values<high. In step 1706, three counts are made in tile_{CL}, corresponding to the number of values in tile_{CL} that are (respectively) greater than, equal to, or less than high. The count implementation may be affected in a number of ways, depending upon the manner in which circular lists are locally implemented. In one embodiment of the present invention, the system uses one loop to count tile_{CL} nodes with values=high, and exits immediately if a tile_{CL} node value>high. Similarly, the system employs another loop to look for tile_{CL} values<high, exiting immediately as soon as a value meeting this condition is determined.

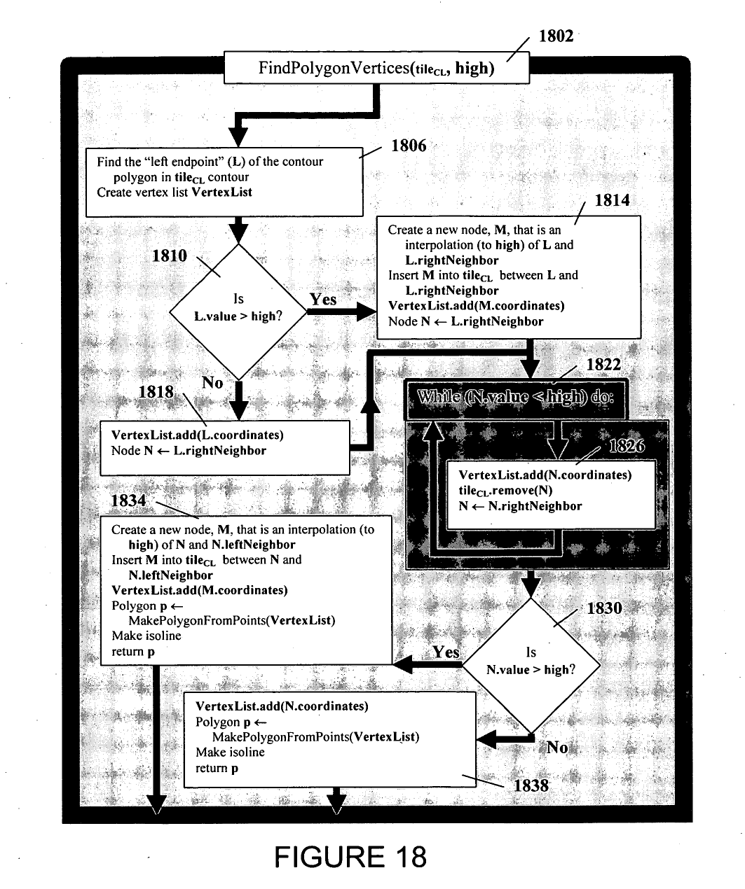

The process continues to step 1710. If one or more values>high are found, the process continues to step 1730. If one or more values<high are found, that means that there must be one or more values within the requested range low≦values<high. The process thus passes to step 1734, where the contour polygon for the current contour level is extracted from tile_{CL} (see FIG. 18). However, if in step 1730 the system determines that no values<high, then the system determines that there is no contour polygon in tile_{CL} for the current contour level, and the system and method of the present invention simply exits without returning a polygon.

If, in step 1710, the system determines that no values>high, then that means that all values in tile_{CL} are ≦high, which in turn means that a special case of analysis may apply, depending on how many of tile_{CL}'s values=high. One special case is dealt with in step 1714, where zero or one of tile_{CL}'s values=high. This means that either no “corners” or one “corner” of the tile=high; and the rest of the values must be <high. In such a case, the process passes to step 1718, where the entire list of points is turned into a polygon and returned. Another special case is handled in step 1722, where two “corners” (i.e., a “side”)=high, with the rest of the values<high. In this case, the processes passes to step 1726. Here, an isoline can be drawn for the “side” before making a polygon (from all points in tile_{CL}) and returning it.

If the test in step 1722 fails, that means that there must be three or more points=high in tile_{CL}. These points constitute a contour polygon (at the contour level above the current one) so the system and method of the present invention determines, in step 1730, if values<high exist. As before, if values<high exist, they are extracted, and an appropriate contour polygon is made via the work in step 1734.

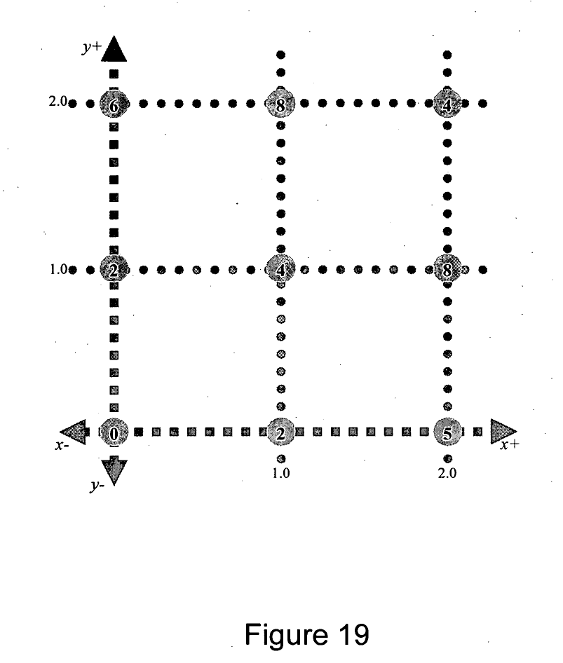

FIG. 18 illustrates how the system and method of the present invention extracts a contour polygon from tile_{CL}, by traversing the circular list of nodes and by making a “vertex list” of coordinates that represent the contour polygon. A pictorial walkthrough of this entire process is illustrated in detail in FIGS. 19-50. The system and method of the present invention starts at step 1802, with at least one value in tile_{CL}<high and at least one value in tile_{CL}≧high. In step 1806, the “left leg” (see additional explanation regarding “left leg” in FIGS. 19-50) is found, with L representing the node at the “left endpoint” of the “left leg”. In Step 1810, the system and method of the present invention determines whether interpolation is needed for the “left endpoint” of the contour polygon, and performs this interpolation in step 1814 if it is needed. If interpolation is not needed, then L becomes the first entry in the vertex list and is the “left endpoint” of the contour polygon. Otherwise, the interpolated point created in step 1814 (M) is used.

The system and method of the present invention then begins to “walk around” tile_{CL} by creating a temporary node variable (N), which serves in the control condition for the loop begun in step 1822. If at least one value in tile_{CL}<high and at least one value in tile_{CL} ≧high, it is inevitable that a value≧high will be found, so the system and method of the present invention “walks” counterclockwise around tile_{CL} until it finds a value≧high while (step 1826) adding “interior points” (see FIGS. 19-50) to the vertex list while removing them from tile_{CL}. Once the value≧high is found, the loop exits and another interpolative check is made in step 1830, similar to the one performed in step 1810 except that now the “right endpoint” of the contour polygon is being determined. If interpolation is needed, it is performed in step 1834, and the interpolated point is added to the vertex list. Otherwise, the last node found in the “walk” is added to the vertex list in step 1838. In both cases, the system and method of the present invention can draw the appropriate isoline (if desired) by using the first and last entries in the vertex list (i.e., “left” and “right endpoints” of the contour polygon) as endpoints. The contour polygon is then returned, with the added bonus that tile_{CL} is up to date since the “interior points” for this contour level have been removed. That is, tile_{CL} can now be utilized in processing the next contour level.

The method of the present invention is reliably fast and accurate, with tight performance bounds and robust behavior even for extremely pathological data. A typical execution time is Ω (XYZ), where X is the number of rows in the gridded data, Y is the number of columns, and Z is the number of requested contour levels. In addition, the method of the present invention is extremely amenable to data-parallel operations, offering the potential for realtime analysis on highly parallel architectures.

As shown in the example above, the system and method of the present invention employs data sampled in a grid, with a+1 rows (indexed 0..a) and b+1 columns (indexed 0..b). For expedience, three functions are defined:
val(i,j)[Aij, 0<=i<=a, 0<=j<=b]=the sampled value at the sampling point ij
lat(i,j)=the latitude of the sampling point i,j
lon(ij)=the longitude of the sampling point i,j

For convenience, a data type known as ContourPoint is defined. ContourPoint has these attributes:
lat: the latitude of the contour point
lon: the longitude of the contour point
val: the sampled or interpolated value at the contour point
ContourPoint has these operations:
getLat( ): returns the value of the lat attribute
getLon( ): returns the value of the Ion attribute
getVal( ): returns the value of the val attribute
setLat(newLat): sets the value of the lat attribute to newLat
setLon(newLon): sets the value of the lon attribute to newLon
setVal(newVal): sets the value of the val attribute to newVal

Additionally, when a new instance of a ContourPoint is created, it can be initialized with lat, lon, and val values, thusly:
new ContourPoint(newLat, newLon, newVal)

The method of the present invention employs a data structure known as a circular doubly-linked list. This is a circular list, with no “beginning” or “end.” This allows sequencing in either a clockwise or a counterclockwise direction. To determine which list position will be the location of the next insertion, deletion, or element inspection, a current index is maintained that can be adjusted as needed. This index can range from 0 to n−1, where n is the number of elements currently in the list, and the indices are arbitrarily laid out in increasing order counterclockwise. Element 0 is bounded by element 1 (in a counterclockwise direction) and element n−1 (in a clockwise direction). For convenience, this data type is called CircList. Below is a list of the operations defined for CircList:
add(obj): inserts obj in between list element 0 and list element n−1
setCurrentIndex(i): sets the current index to i if 0<=i <=n−1
getCurrentIndex( ): returns the current index (in the range 0..(n−1)
moveClockwise( ): move the current index 1 position clockwise, wrapping around to n−1 if the current index was 0
moveCounterclockwise( ): move the current index 1 position counterclockwise, wrapping around to 0 if the current index was n−1
getCurrentElement( ): returns the list element at the current index
clear( ): remove all elements from the list
addAndMaintainCurrentIndex(i, obj): insert obj at position i, but maintain the current index where it is
addAndSetCurrentIndex(i, obj): insert obj at position i and set the current index to i
addAfterPositionAndMaintainCurrentIndex(i, obj): insert obj at position i+1, but maintain the current index where it is
removeAndMaintainCurrentIndex(i): remove the list element at index i, but maintain the current index where it is
resetCurrentIndex( ): sets the current index to 0
peekAheadClockwise( ): returns the list element at the next position clockwise from the current index
peekAheadCounterclockwise( ): returns the list element at the next position counterclockwise from the current index
replaceCurrentElement(obj): replace the list element at the current index with obj

FIGS. 19-50 illustrate in additional detail the manner in which a gridded data set is analyzed using a circularly linked set of coordinates.

To illustrate the use of the circular list, in FIG. 19, a sample data set is illustrated. FIG. 19 illustrates a starting situation, before any contours are drawn or shaded. Collected data samples are shown at the Cartesian intersections for all values of X {0.0, 1.0, 2.0} along the x-axis (horizontal axis), and for Y {0.0, 1.0, 2.0} shown along the y-axis (vertical axis). Sample values are shown in shaded circles at these intersection points. Dotted and dashed lines, drawn at x-values and y-values corresponding to sample points, illustrate the inherent grid of data.

As shown in FIG. 20A, and described using pseudo-code in the attached Appendix, the system and method of the present invention processes the grid squares sequentially, one by one, starting in the bottom left corner of the grid and working methodically left-to-right, row by row. The system and method of the present invention identifies the four corners of the tile, and each corner is stored as a ContourPoint. The system checks for degeneracies by evaluating the corner points. The corner points are the starting circular list illustrated in FIG. 20B. That is, the elements of the circular list correspond to the corners of the highlighted grid square. The elements of the circular list are the boundaries of the area still to be contoured within the current grid square.

The circle of FIG. 20B illustrates the starting circular list before any contouring is done. The elements of the circular list correspond to the corners of the highlighted grid square, where the value of the coordinate is shown raised above the x-coordinate and the y-coordinate. This convention is maintained throughout the description of the processing of the circular coordinates. The elements of the circular list are the boundaries of the area within the current grid square to be contoured. That is, the points represent the internal set of data points in the tile, starting with the entire defined tile. As contouring continues, the set of points is progressively refined as contour areas are extracted.

As illustrated in FIGS. 21A and 21B, the system and method of the present invention processes the first contour level, 5.0, and determines that the entire selected grid square falls within the first contour level. That is, all values are less than 5.0. In this example, the lowest contour level is 5.0, so the leftmost line segment that fits in the present contour is the entire line segment between coordinates (0,0) and (0,1) because the values range from 0 at (0,0) to 2 at (0,1). All values along the line segment are smaller than this smallest contour level of 5.0, so all points along the line segment are in the contour region. The same is true of the horizontal line segment between (0,0) and (1,0) as well as the horizontal line segment between (1,0) and (1,1). Lastly, the vertical line segment between (1,0) and (1,1) includes values from 2 to 4, so all points along this vertical line segment are in the contour region as well. The system and method of the invention creates a list of coordinates, shown in the chain of ellipses in FIG. 21B, that represents the boundary points of the polygon to be shaded. In this case, the contents of this list are the points shown in the circular list of FIG. 20B. The system passes this list to a renderer, which shades the region as shown in FIG. 21A. The circular list is now empty—the entire selected grid square has been shaded.

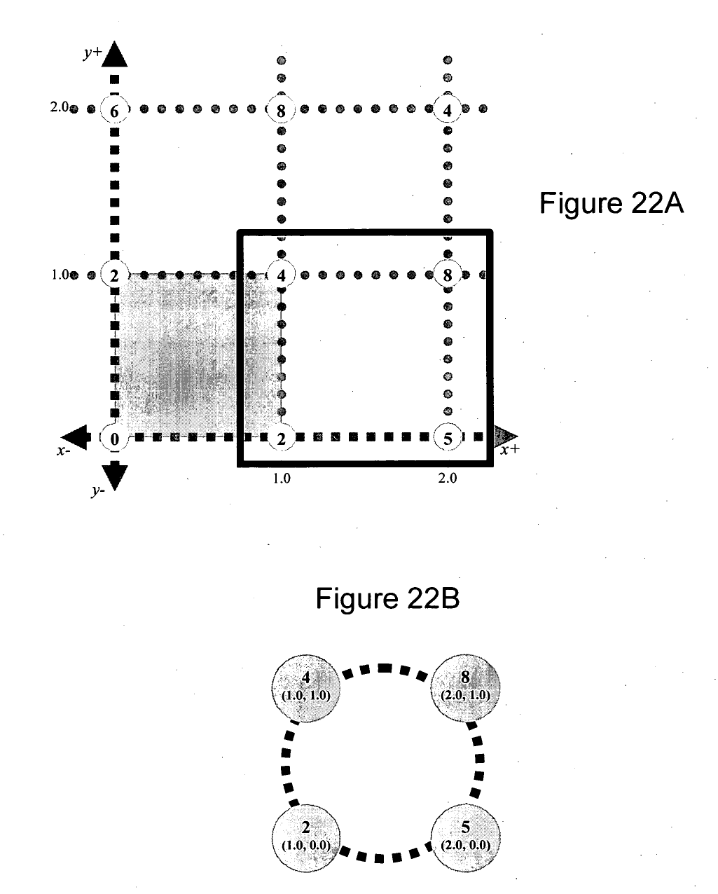

Upon completing the first grid square, the next grid square may be processed as shown beginning in FIG. 22A. As outlined above, the system and method of the present invention processes all contour levels in order in each grid square before sequentially moving on to the next grid square. Since the first grid square is complete, the second grid square is analyzed beginning with the first contour level of 5.0. The circular coordinates for this second grid square are shown in FIG. 22B.

As shown in the circular coordinate list in FIG. 22B, the second grid square includes values greater than the first contour level 5.0. For example, the corner point at coordinates (2.0, 1.0) has a value of 8, which is larger than the first contour level 5.0. Therefore, the system must identify the left and right line-segments bounding the present contour of 5.0. To do this, the system and method first determines the left endpoint by examining the circular coordinates for the second grid square.

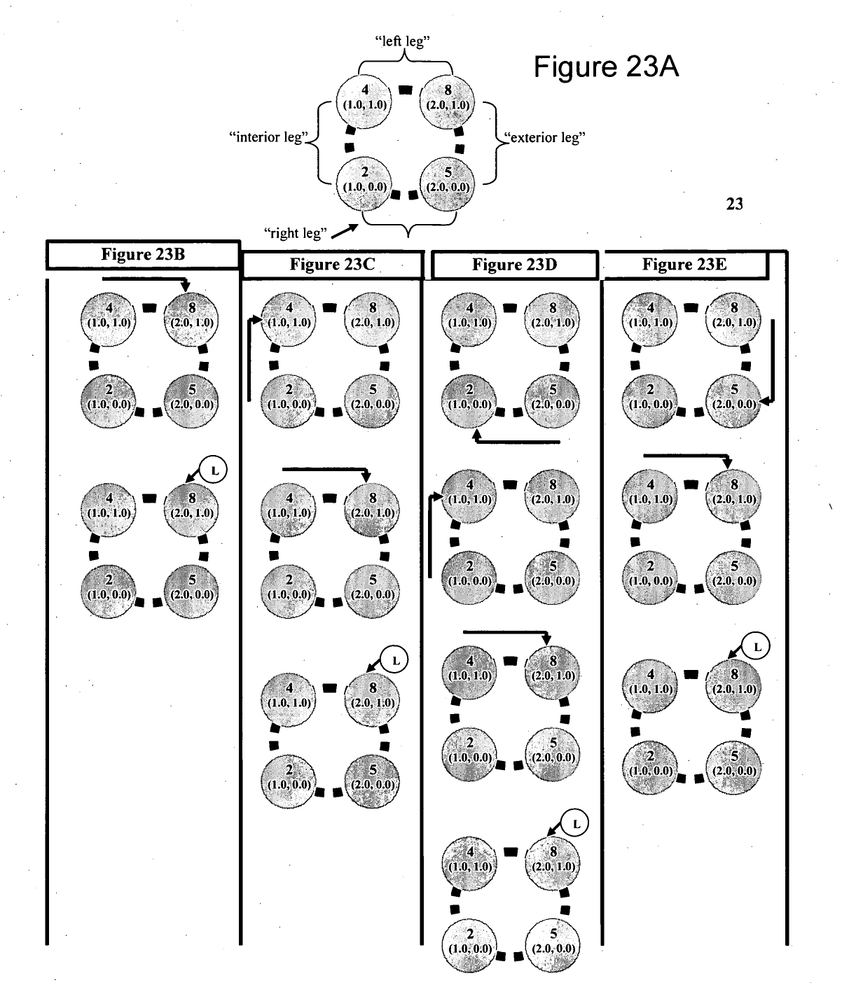

As shown in FIG. 23A- FIG. 23E, while it is visually easy to determine the line segments bounding the contour level, it is rather involved to determine the contour level by examining the circular coordinates.

FIGS. 23A-23E illustrate a manner in which the system and method of the present invention finds the left endpoint of the circular list of coordinates. In FIGS. 21-22, the first grid square (tile) processed had values all falling within the first contour level, 0≦values<5. The invention handled this case quickly, and the process now must deal with a grid square (tile) with a wider range of values as illustrated in FIG. 23A. As described above with regard to FIGS. 14-18, the process checks to see if the grid square is degenerate, and subdivides the tile as necessary into nondegenerate subtiles. Next, the process checks to see if all circular list values are the same, then checks to see if all values would fall within the current contour level. If either case holds true, the system and method of the present invention completes the contour and moves on to the next tile. Otherwise, the process determines if the circular list has any values that fall within the contour level. If the circular list does include these values, the system determines that the circular list must contain at least one value<the current contour level and at least one value≧the current contour level.

In determining these characteristics of the circular list, the system further determines that the circular list has two “halves,” namely the contiguous sublist of nodes that are fully “interior” (i.e., value<contour level), and the remaining contiguous sublist of nodes that are “exterior” (i.e. value >contour level). As illustrated in FIG. 23A, the system and method performs what can be analogized as a walk around the “interior” sublist to the “left” (clockwise), eventually finding the “left leg”, which is the two-node segment where the “left” node≧contour level and the “right” node<contour level. If the system and method were instead to walk around the “interior” sublist to the “right” (counterclockwise), the system and method will find the “right leg” (the two-node segment where the “right” node≧contour level) and the “left” node<contour level.

If the process walks counterclockwise from the “left leg” to the “right leg”, any two-node segments traversed in which both points are<contour level (i.e., “interior points”) constitutes an “interior leg”. Conversely, if the process travels from the “left leg” to the “right leg” counterclockwise, any two-node segment traversed in which both points are≧contour level (i.e., “exterior points”) constitutes an “exterior leg”.

The example illustrated in FIG. 23A depicts all four types of legs. Note that the “left leg” contains the contour level (i.e., 5.0 is between 8.0 and 4.0) while the “right leg” includes the contour level as one of its endpoints (in this case, as the “right” endpoint).

In FIGS. 23A-23E, a method of finding the “left leg” segment is shown. The determination begins by arbitrarily choosing a node and treating it as the “left” endpoint of the leg under examination.

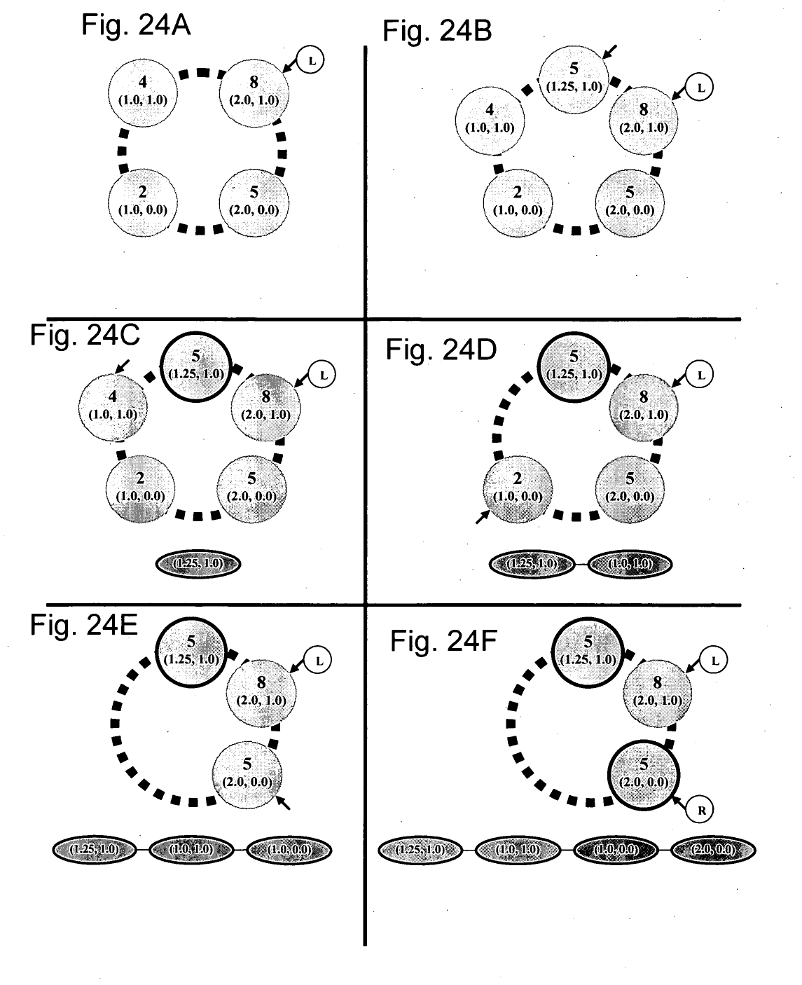

As shown in FIG. 23B, the chosen node is determined to be the “left leg.” This determination is verified because the “left” endpoint≧contour level and the “right” endpoint<contour level. The system marks the “left” endpoint as “L” and moves on to the next step in the process shown in FIG. 24.

As illustrated in FIG. 23C, rather than lucking out and arbitrarily choosing the left endpoint as was done in FIG. 23B, if the process in FIG. 23C begins on an “interior leg” (the system determines it is an interior leg because both points are<contour level), the process is to move clockwise until the system determines the leg that has a “left” endpoint≧contour level, which must be the “left leg.” As was the case in FIG. 23B, the system marks the “left” endpoint as “L” in FIG. 23C and moves on to the next step in the process shown in FIG. 24.

In FIG. 23D, the process arbitrarily chose the “right leg” (the system recognizes it is the right leg because the “right” endpoint≧contour level and the “left” endpoint<contour level). As an efficiency measure, the system marks the “right” endpoint of this leg as the “right” endpoint of the polygon that is being constructed. Then, as in FIG. 23C, the process moves clockwise until it determines the “left leg.” The system makes the proper notation, marking the “left” endpoint as “L” in FIG. 23D and moving on to the next step in the process shown in FIG. 24.

In FIG. 23E, the system has chosen an “exterior leg” (the system recognizes it is an exterior leg because both endpoints >contour level). In this case, the process moves counterclockwise until it determines the “left” leg, since the loop is easier to implement. That is, the process moves counterclockwise until it determines the first leg whose right endpoint<contour level.” As was the case in FIGS. 23B-23D, the process then marks the left endpoint “L” appropriately in FIG. 23E and moves on to the next step in the process shown in FIG. 24.

FIGS. 24A-24F illustrate the determination of the right endpoint and the creation of the polygon coordinate list while doing so.

Having found the “left leg” of the contour polygon in FIGS. 23A-23E, the system and method of the present invention now “walks” to the “right” endpoint of the contour polygon, interpolating as necessary at the endpoints and adding end and “interior” nodes to a “vertex list” as the method progresses. If a node is strictly “interior”, it is removed from the circular list.

FIG. 24A depicts the status of the circular list at this point in the process. That is, after executing the process shown and explained with regard to FIGS. 23A-23E. Since the “left leg” contains but, in this case, does not include the requested contour level (5.0), the system must create an interpolated point between the endpoint coordinates of the “left leg” and insert this new node in the circular list between the “left leg's nodes.” This interpolation is illustrated in FIG. 24B. Note that the x- and y-coordinates of the new node are interpolated appropriately between the x- and y-coordinates of the 4 and 8 nodes.

In FIG. 24C, the system now creates a “vertex list” of coordinate pairs that will form the perimeter of the contour polygon. The first pair on the list are the coordinates just created in FIG. 24B. However, if the system did not require an interpolation, the first pair on the list would be the coordinates of the “L” node, since that node would have had a value=contour level.

The process begins by walking counterclockwise around the circular list. If the next node evaluated is<contour level (such as the 4 node is in FIG. 24C), the system add its coordinates to the vertex list and remove it from the circular list as shown in FIG. 24D.

Also, as shown in FIG. 24D, the system and method processes another interior node (node 2), adding its coordinates to the vertex list and removing it from the circular list in FIG. 24E.

In FIG. 24F, the method reaches the “right” endpoint of the contour polygon, which equals the requested contour level and does not require interpolation. The system adds this node's coordinates to our vertex list, but does not remove the node itself from the circular list. Since the system has now determined the right endpoint, it does not need to proceed further.

Optionally, the system may create the polygon using the vertex list created above, and include attribute information particularly to contouring, such as line color and fill color. In one embodiment of the present invention, the line and fill color are set to the same value (for each contour level), which leads to seamless “melding” of neighboring contour polygons.

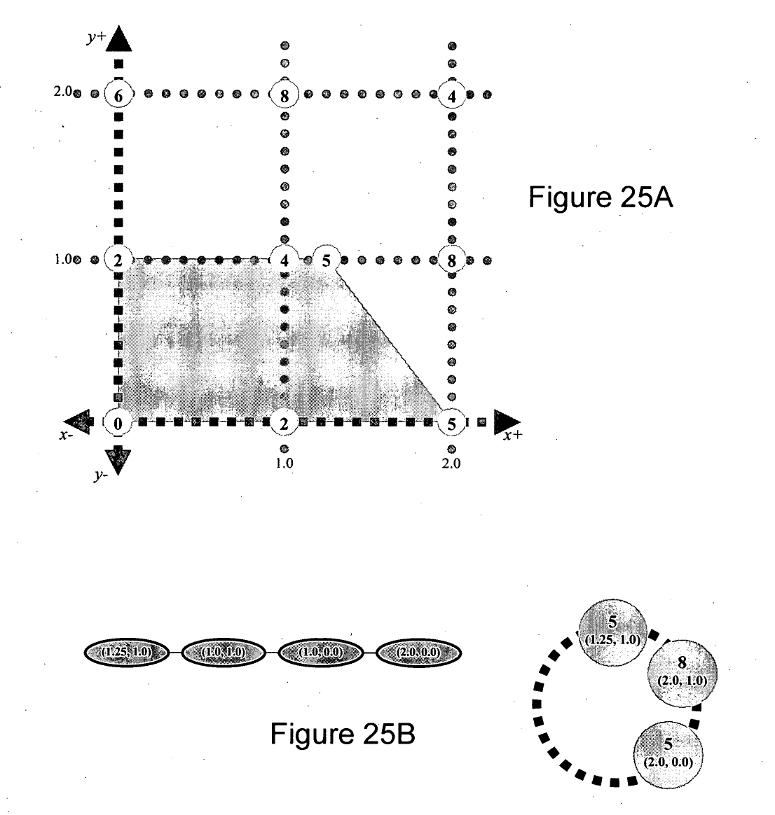

As shown in FIGS. 25A and 25B, the polygon for contour level 5.0 has been drawn. Note that the polygon list and circular list are the same as shown in FIG. 24F.

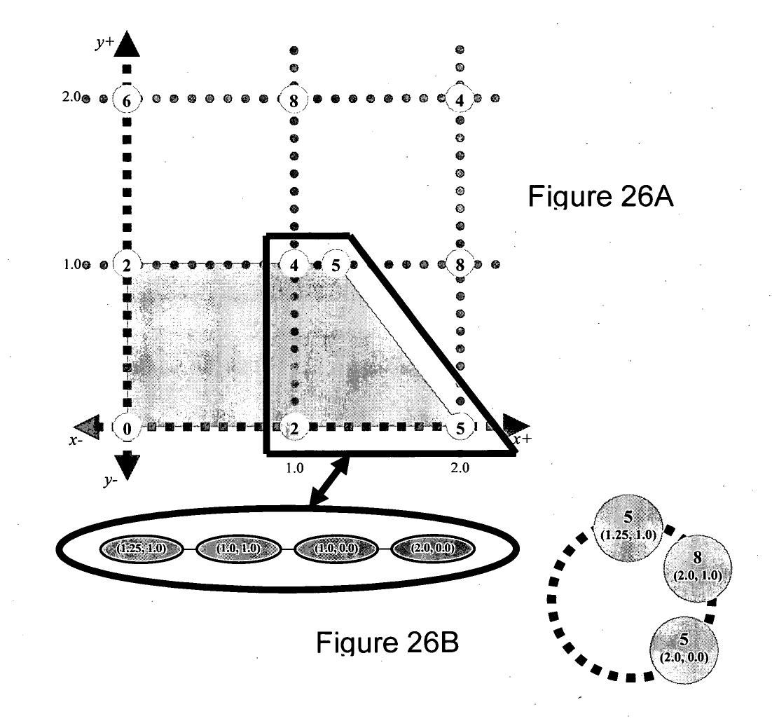

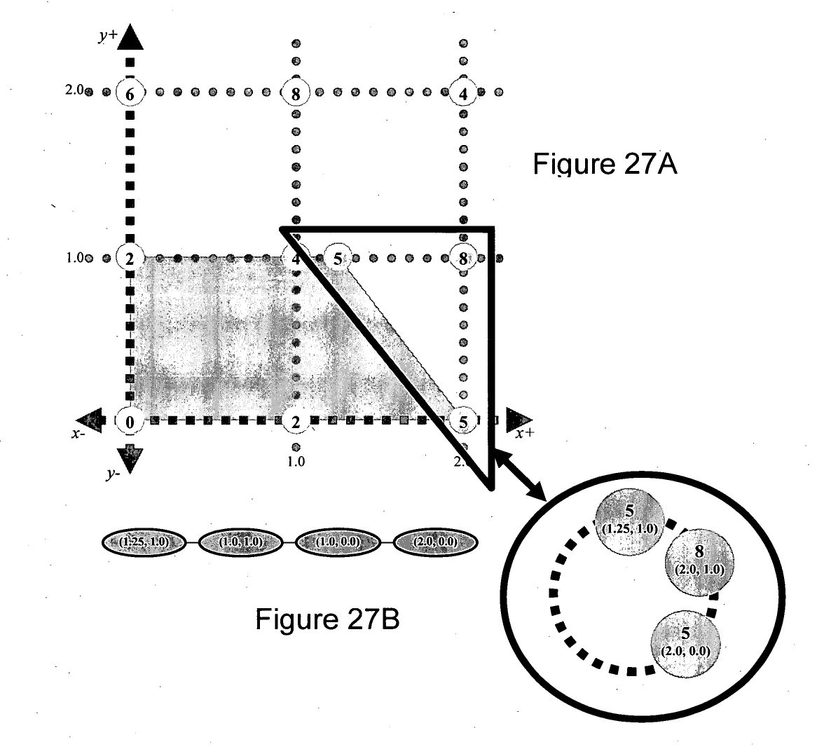

FIGS. 26A and 26B show the polygon list corresponding to the boundary points of the polygon just shaded, while in FIGS. 27A and 27B, the circular list corresponding to the boundary points of the region still-to-be-shaded is illustrated.

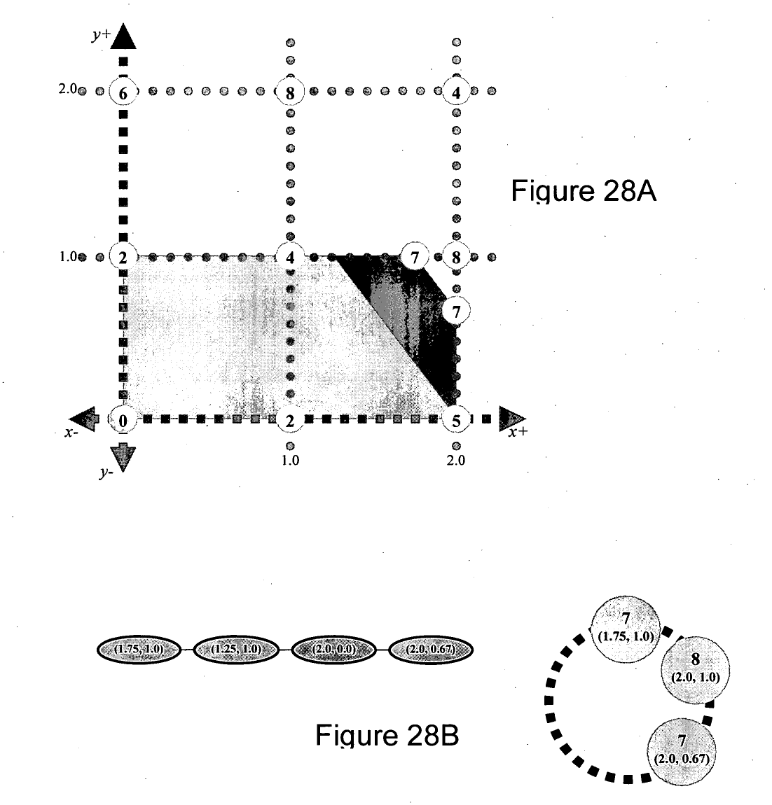

FIGS. 28A and 28B show the polygon point list for contour level 7.0, and the remaining circular list. The two new, interpolated points are also shown.

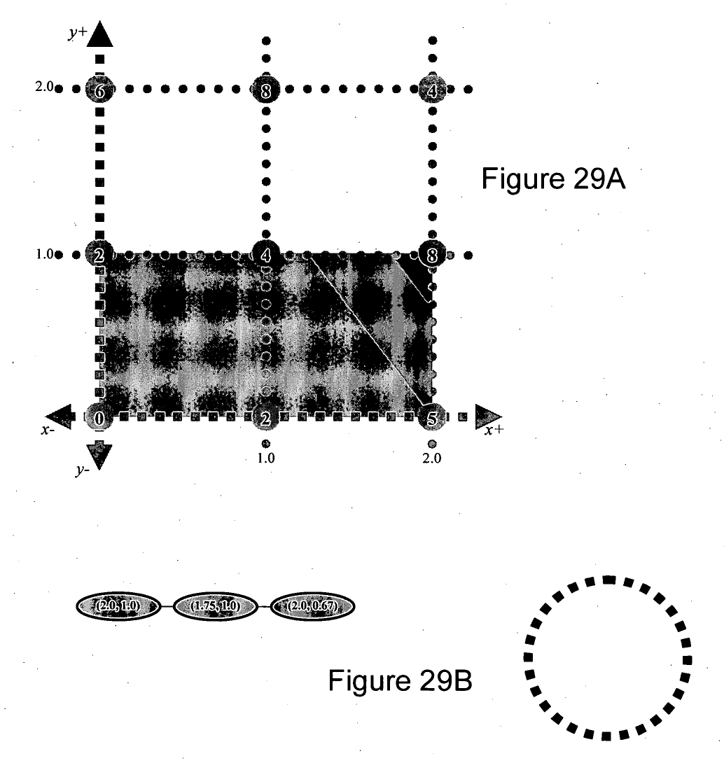

FIG. 29A illustrates the shaded gridded data set in process, while FIG. 29B shows the polygon point list for contour level 9.0, and the remaining circular list (empty).

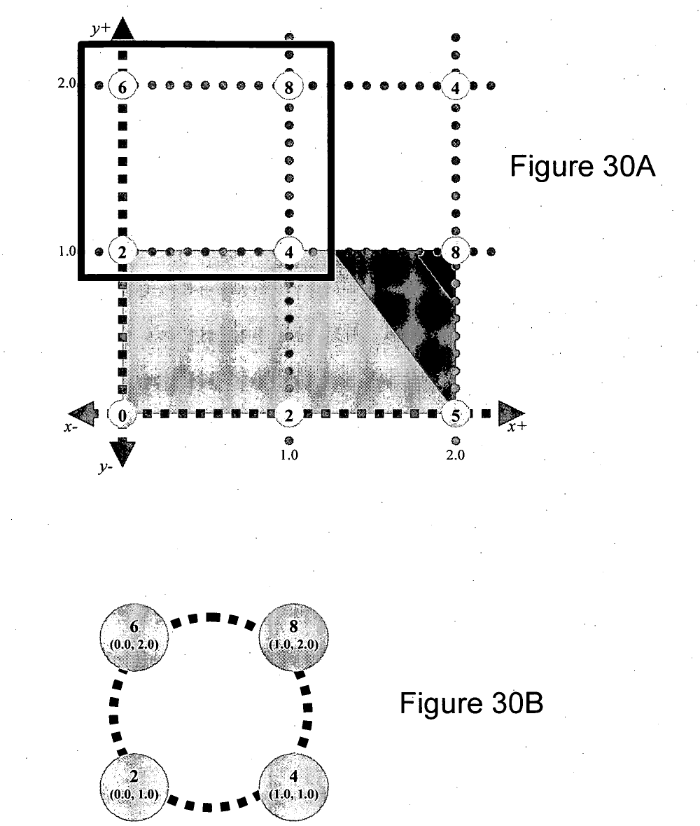

In FIG. 30A, the process continues to the next grid square, with the corresponding circular list shown in FIG. 30B. The system is preparing to process contour level 5.0.

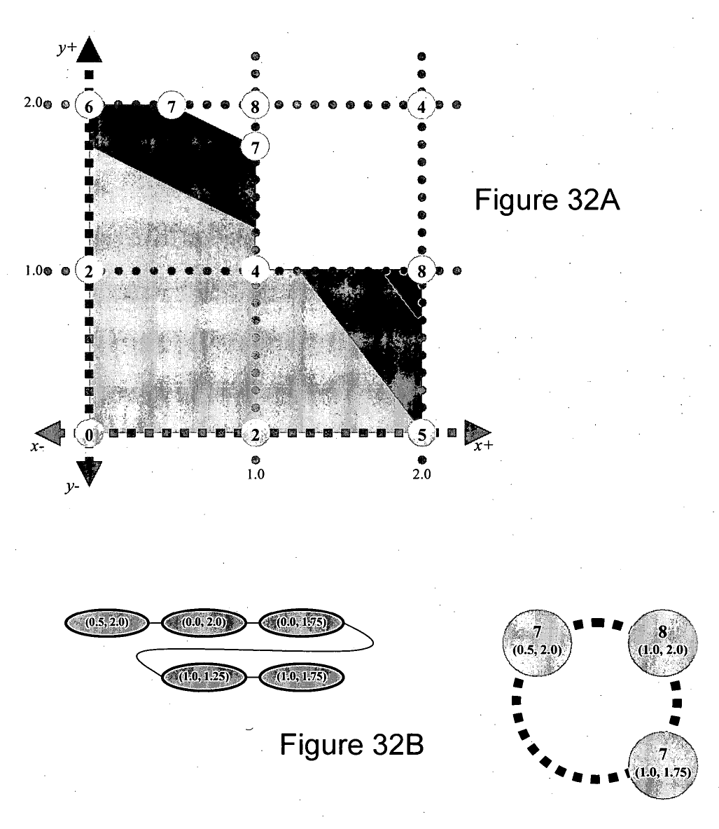

FIGS. 31A and 31B show the polygon point list for contour level 5.0, and the remaining circular list, and FIGS. 32A and 32B depict the polygon point list for contour level 7.0, and the remaining circular list.

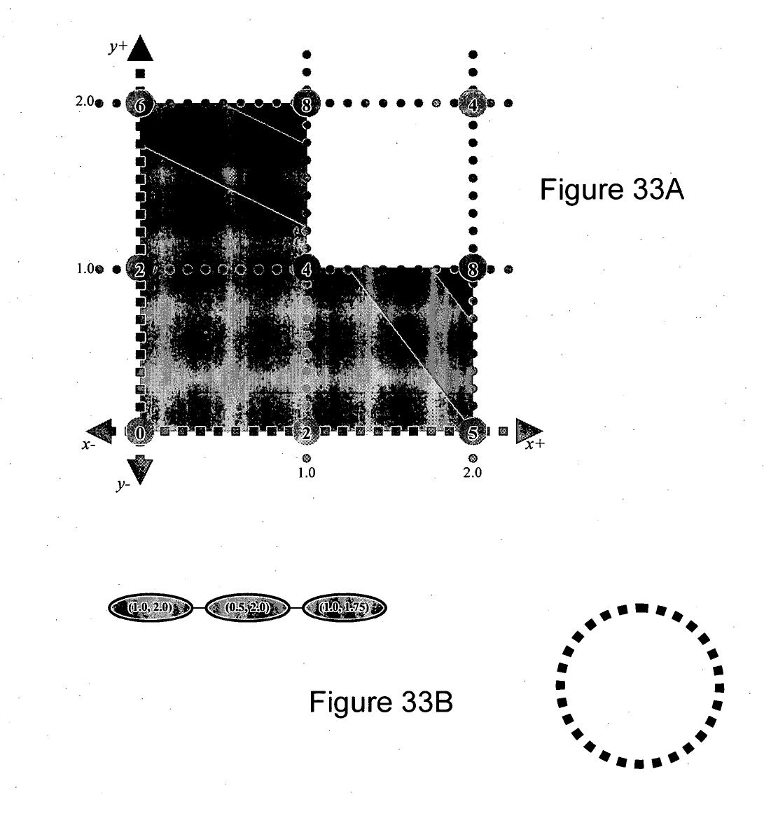

In FIGS. 33A and 33B, the polygon point list for contour level 9.0 is shown, as is the remaining circular list (empty).

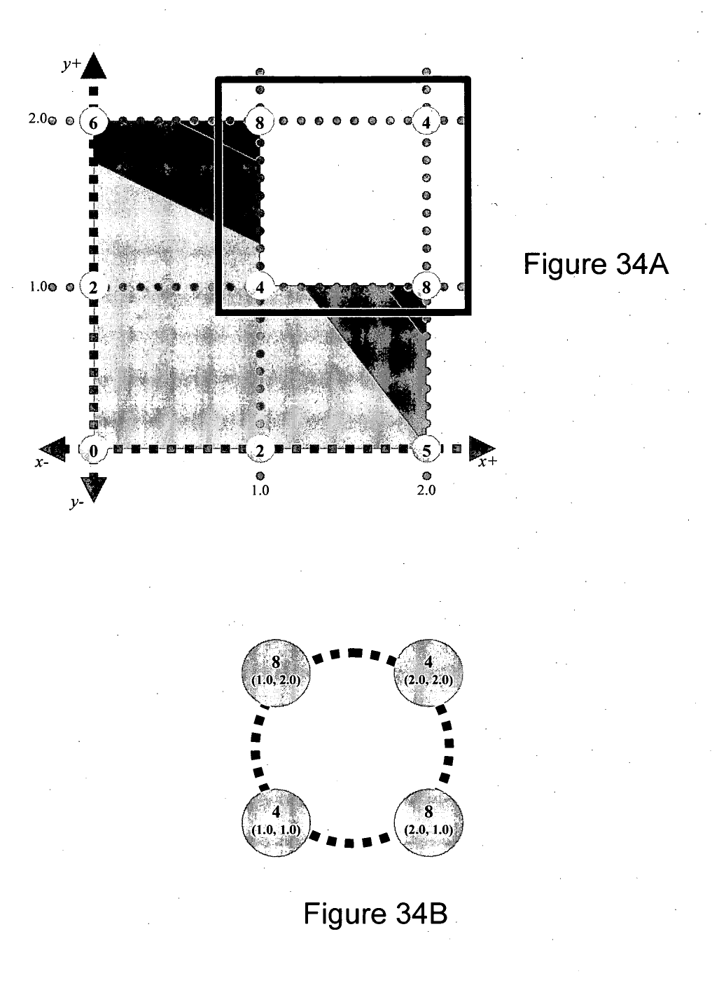

FIGS. 34A and 34B show the status of the process and the coordinate list as the process moves on to the last grid square. This is a degenerate grid square and requires special handling as described above previously in the section entitled Data Degeneracy and in the following figures.

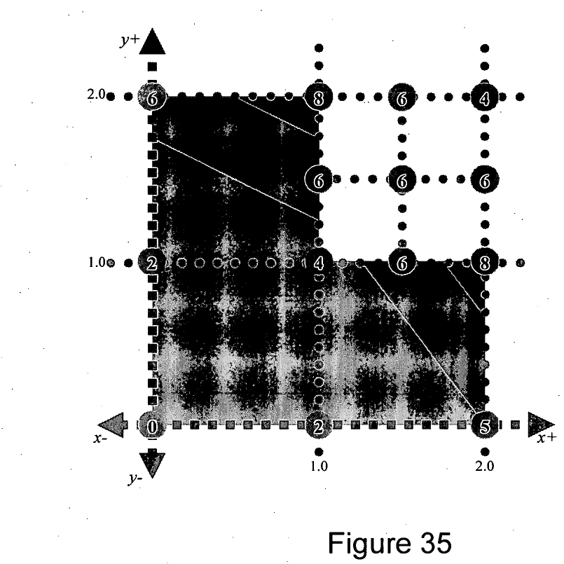

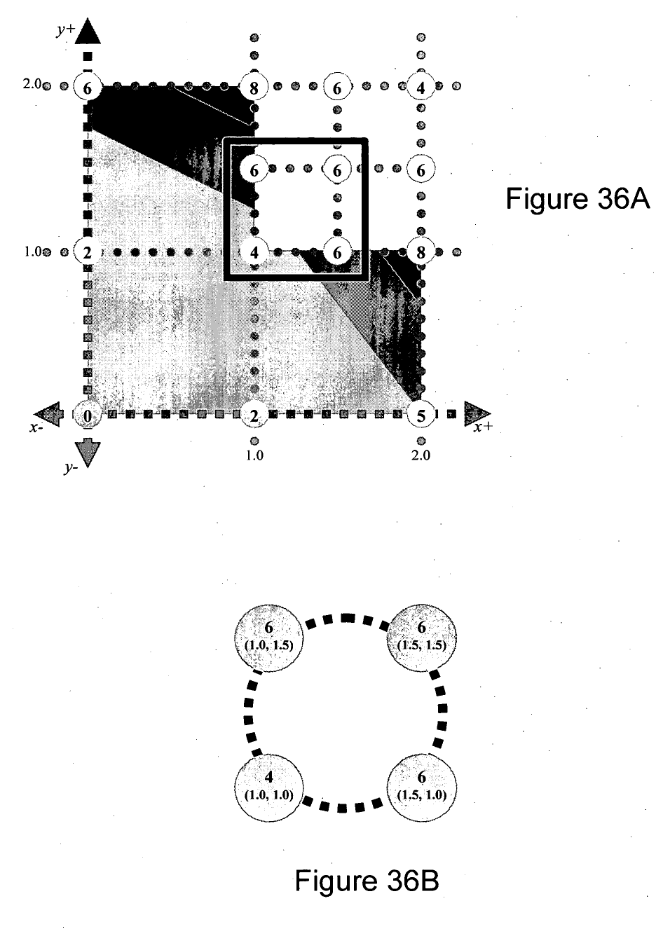

In FIG. 35, the degenerate grid square is divided into 4 subtiles. In FIGS. 36A and 36B, the grid and coordinate list is shown before processing the first subtile. The system is preparing to process contour level 5.0.

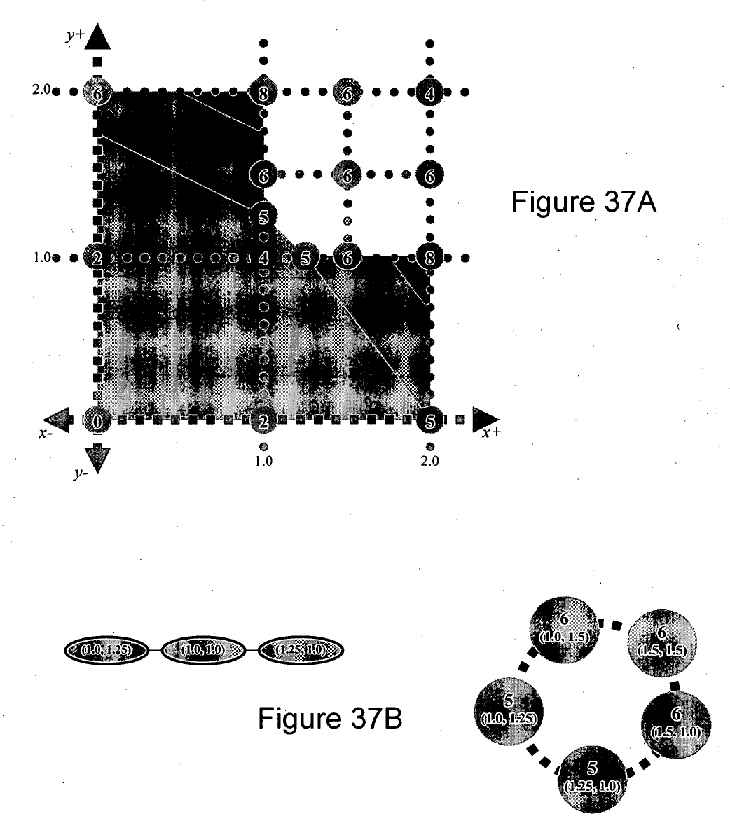

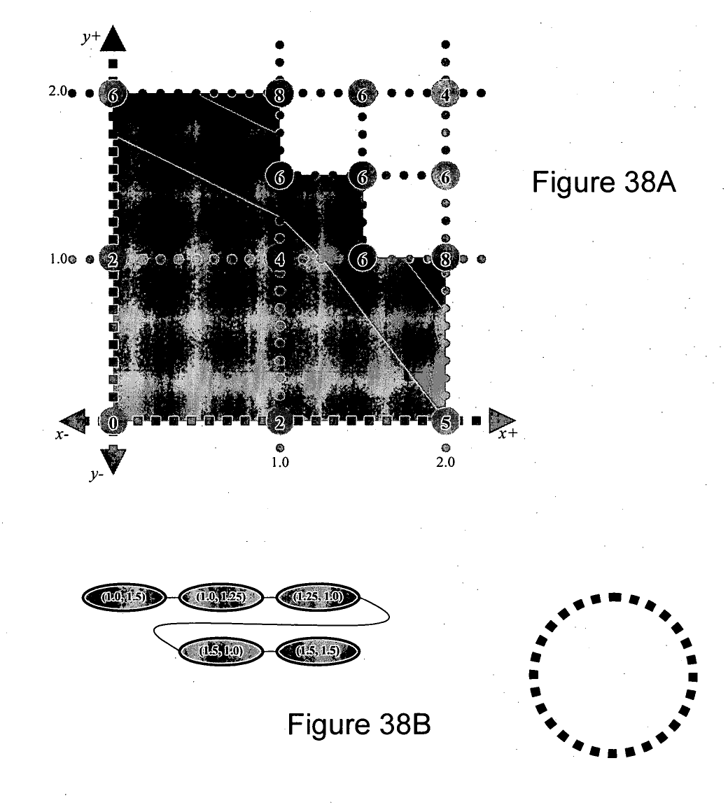

FIGS. 37A and 37B show the polygon point list for contour level 5.0, and the remaining circular list, while FIGS. 38A and 38B illustrate the polygon point list for contour level 7.0, and the remaining circular list (empty).

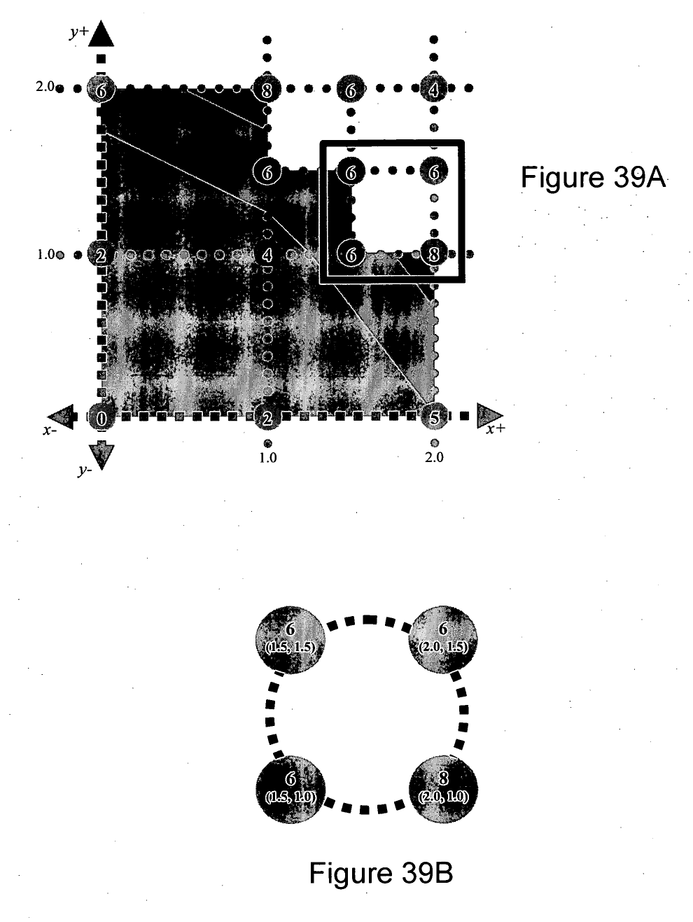

In FIGS. 39A and 39B, the status of the contour shading and the coordinate list is shown as they exist prior to processing the second subtile. The system is preparing to process contour level 5.0.

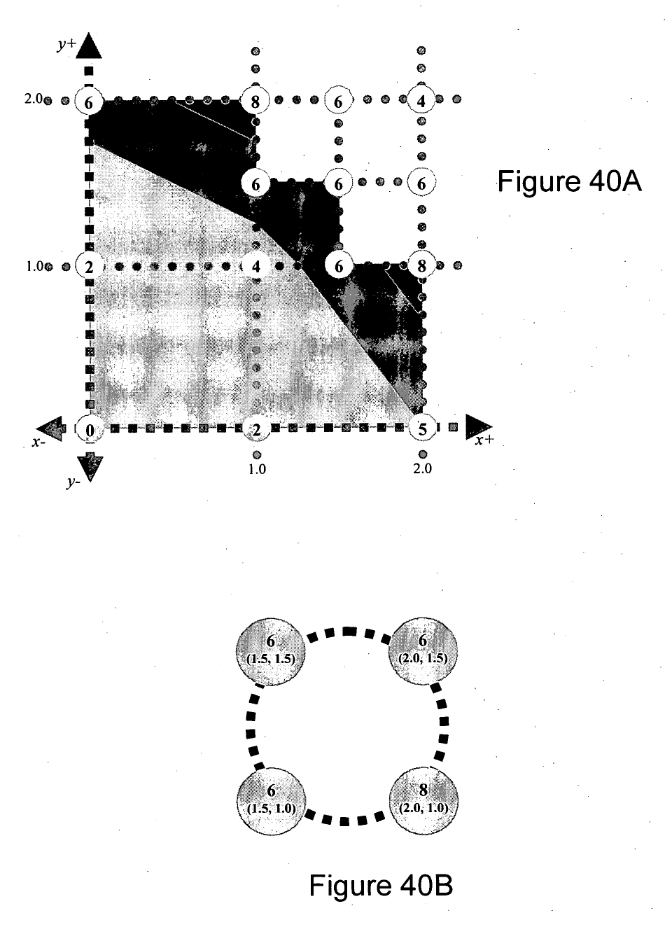

FIGS. 40A and 40B show that all values in the circular list are greater than the current contour level, 5.0, so no polygon is drawn, no change is made to the circular list, and the process moves on to contour level 7.0.

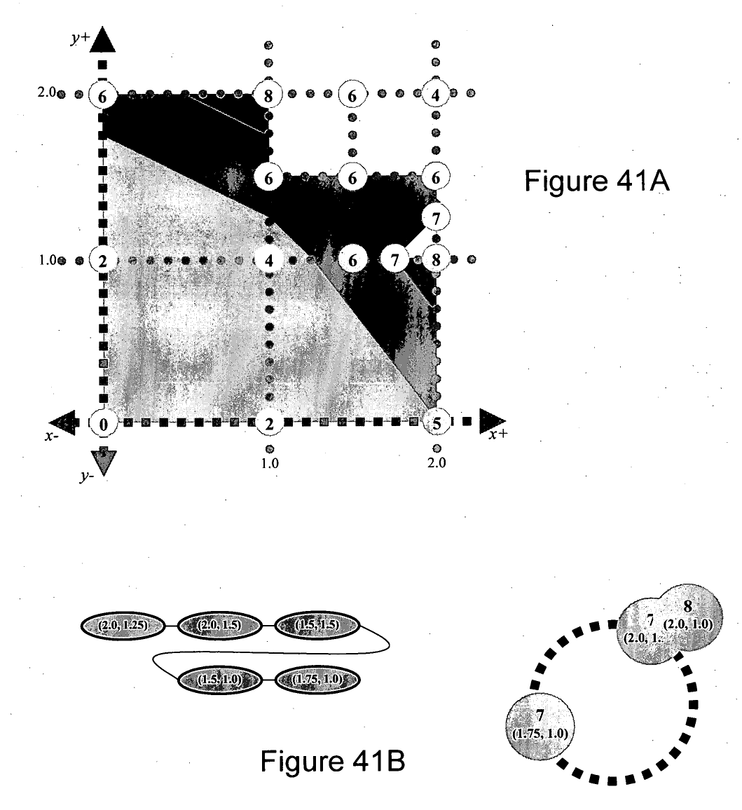

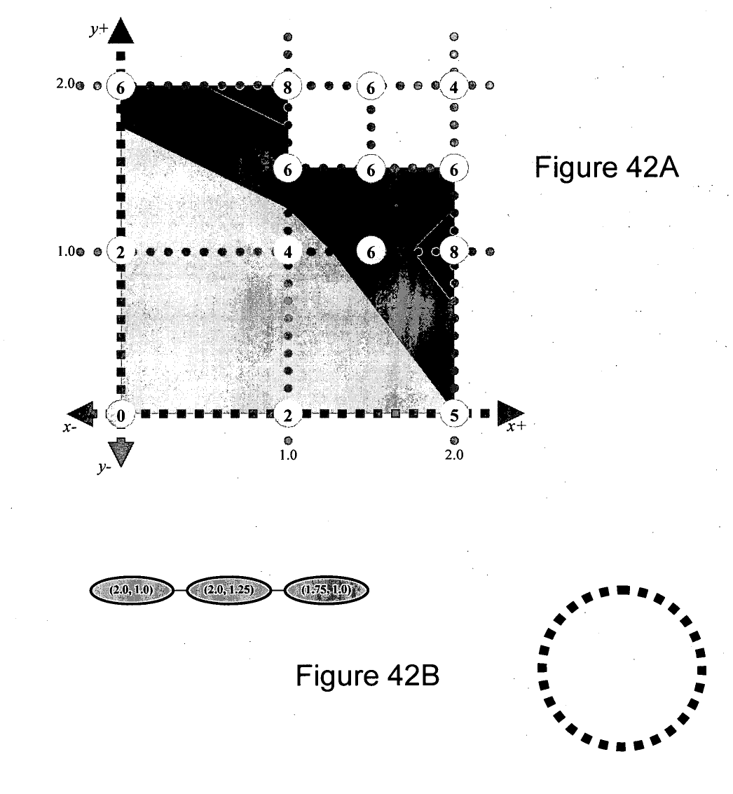

FIGS. 41A and 41B show the polygon point list for contour level 7.0, and the remaining circular list, while FIGS. 42A and 42B show the polygon point list for contour level 9.0, and the remaining circular list (empty).

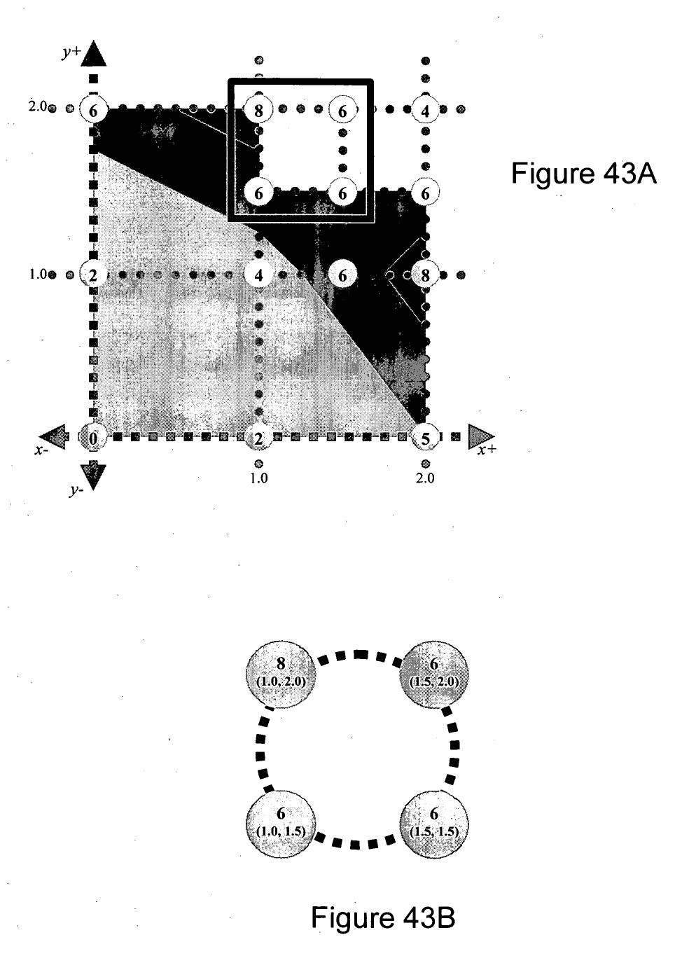

In FIGS. 43A and 43B, the status of the contour shading and the coordinate list is shown as they exist prior to processing the third subtile. The system is preparing to process contour level 5.0.

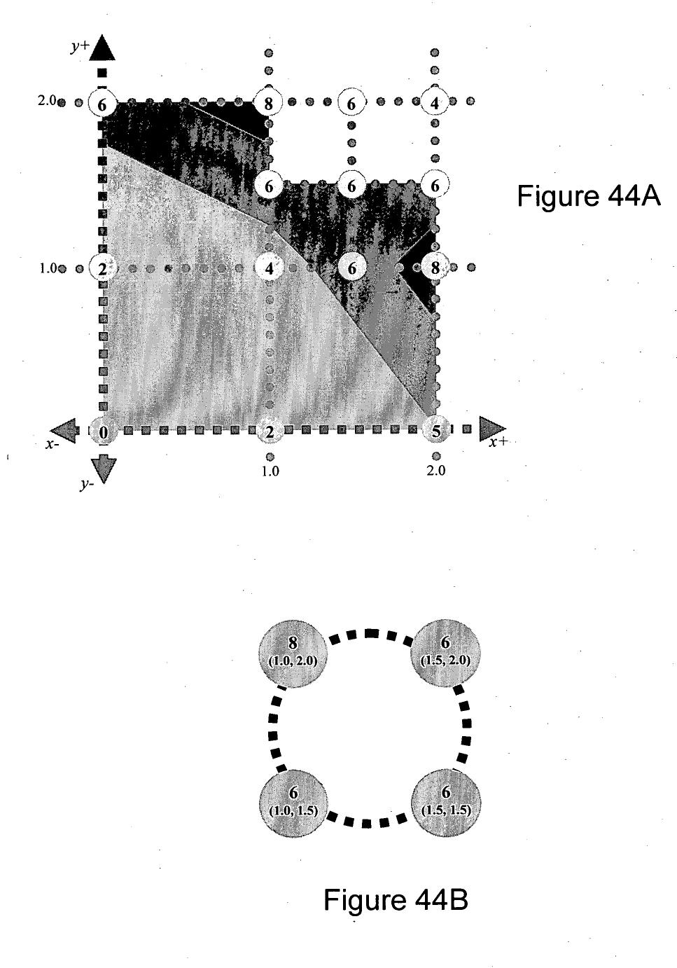

In FIGS. 44A and 44B, all values in the circular list are greater than the current contour level, 5.0, so no polygon is drawn, no change is made to the circular list, and the process moves on to contour level 7.0.

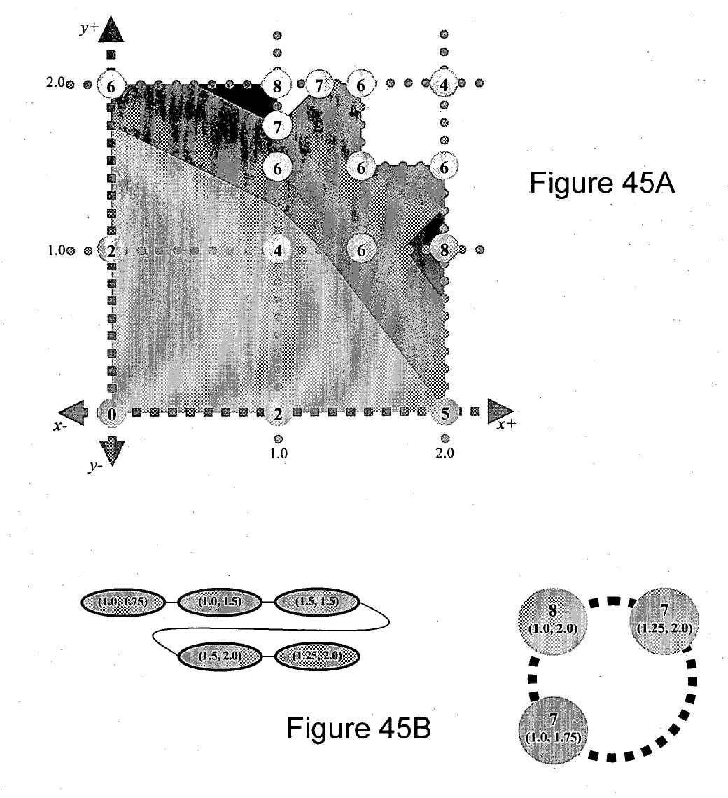

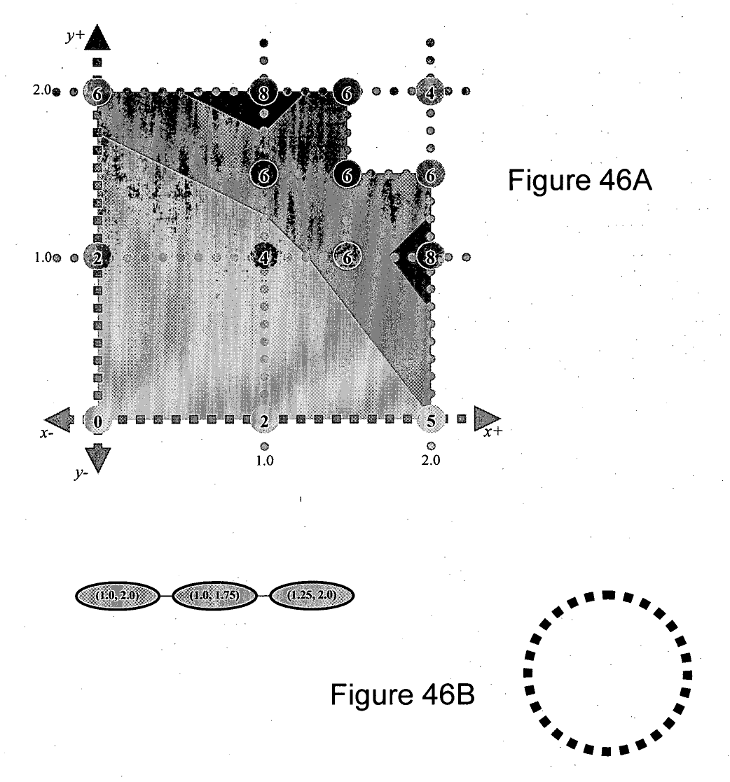

FIGS. 45A and 45B show the polygon point list for contour level 7.0, and the remaining circular list, while FIGS. 46A and 46B illustrate the polygon point list for contour level 9.0, and the remaining circular list (empty).

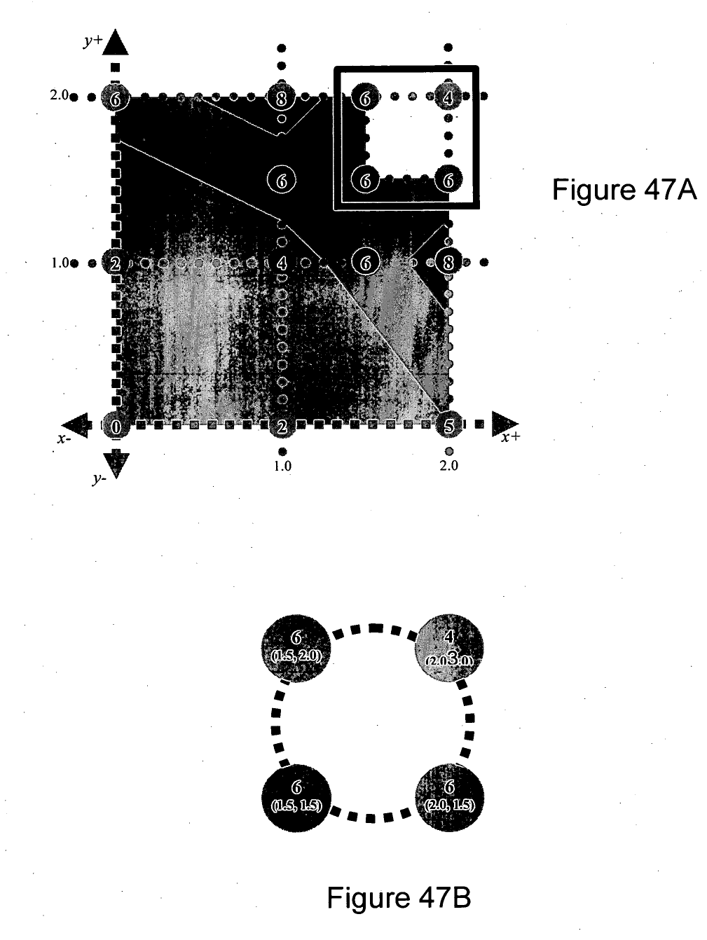

In FIGS. 47A and 47B, the status of the contour shading and the coordinate list is shown as they exist prior to processing the last subtile. The system is preparing to process contour level 5.0.

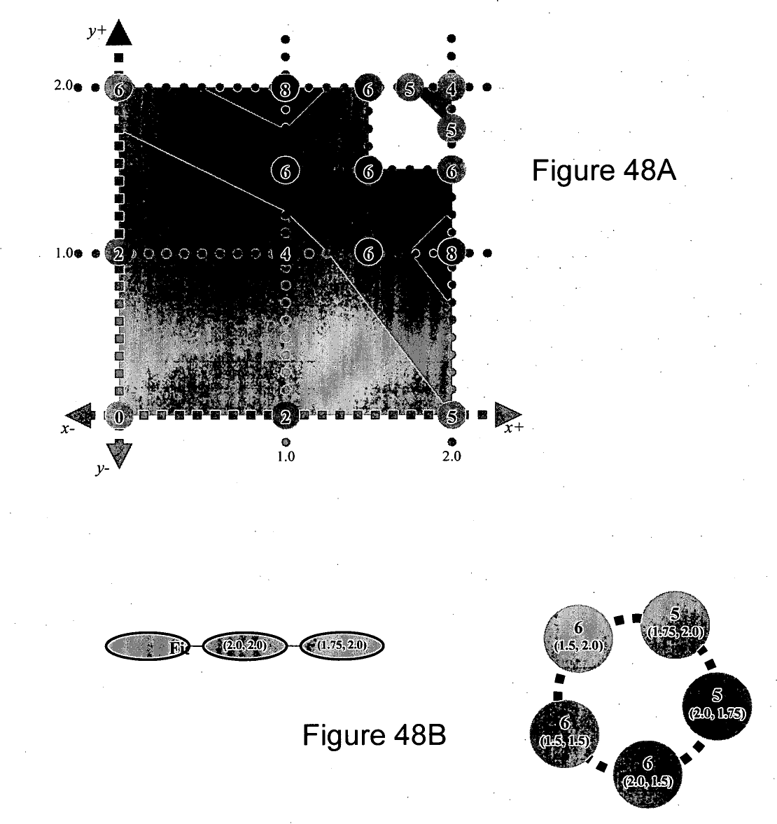

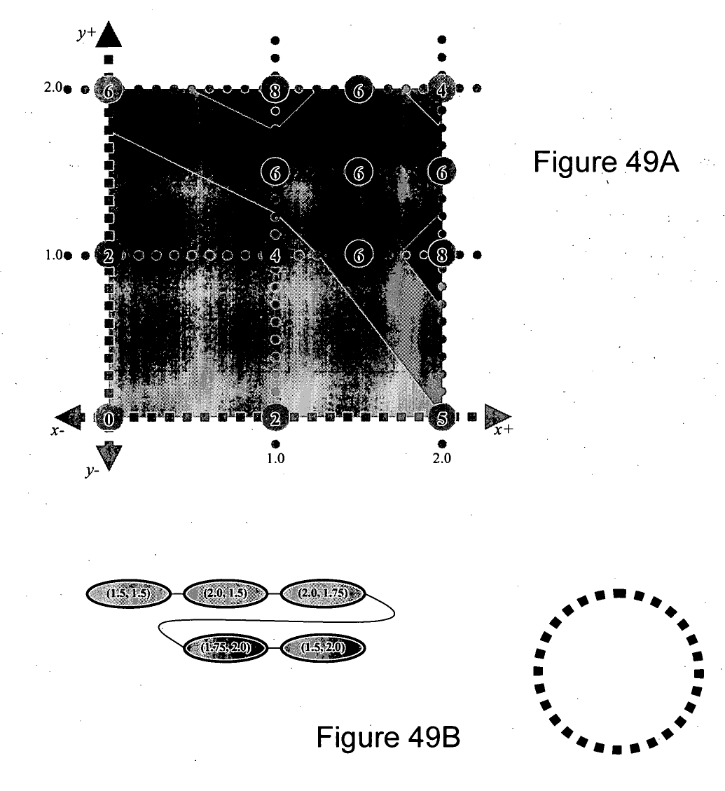

FIGS. 48A and 48B show the polygon point list for contour level 5.0, and the remaining circular list, while FIGS. 49A and 49B illustrate the polygon point list for contour level 7.0, and the remaining circular list (empty).

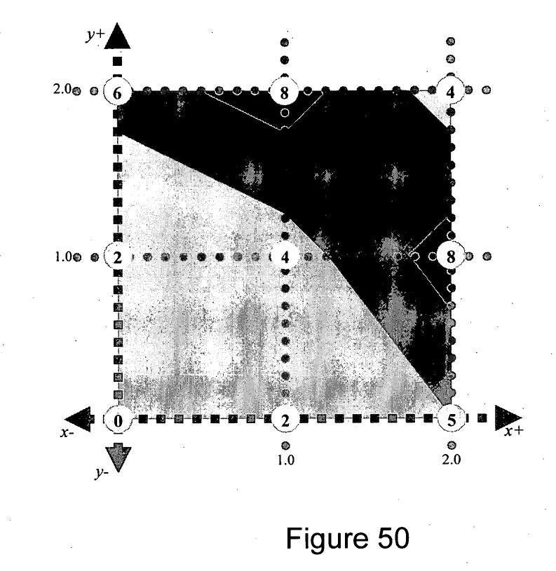

FIG. 50 shows the completed contour shading of the grid of values.

The devices and subsystems of the exemplary embodiments of FIGS. 1-50 are for exemplary purposes, as many variations of the specific hardware used to implement the exemplary embodiments are possible, as will be appreciated by those skilled in the relevant arts. For example, the functionality of one or more of the devices and subsystems of the exemplary embodiments of FIGS. 1-50 can be implemented via one or more programmed computer systems or devices.

To implement such variations as well as other variations, a single computer system can be programmed to perform the special purpose functions of one or more of the devices and subsystems of the exemplary embodiments of FIGS. 1-50. On the other hand, two or more programmed computer systems or devices can be substituted for any one of the devices and subsystems of the exemplary embodiments of FIGS. 1-50. Accordingly, principles and advantages of distributed processing, such as redundancy, replication, and the like, also can be implemented, as desired, to increase the robustness and performance of the devices and subsystems of the exemplary embodiments of FIGS. 1-50.

The devices and subsystems of the exemplary embodiments of FIGS. 1-50 can store information relating to various processes described herein. This information can be stored in one or more memories, such as a hard disk, optical disk, magneto-optical disk, RAM, and the like, of the devices and subsystems of the exemplary embodiments of FIGS. 1-50. One or more databases of the devices and subsystems of the exemplary embodiments of FIGS. 1-50 can store the information used to implement the exemplary embodiments of the present invention. The databases can be organized using data structures (e.g., records, tables, arrays, fields, graphs, trees, lists, and the like) included in one or more memories or storage devices listed herein. The processes described with respect to the exemplary embodiments of FIGS. 1-50 can include appropriate data structures for storing data collected and/or generated by the processes of the devices and subsystems of the exemplary embodiments of FIGS. 1-50 in one or more databases thereof.

All or a portion of the devices and subsystems of the exemplary embodiments of FIGS. 1-50 can be conveniently implemented using one or more general purpose computer systems, microprocessors, digital signal processors, micro-controllers, and the like, programmed according to the teachings of the exemplary embodiments of the present invention, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments of FIGS. 1-50 can be implemented on the World Wide Web. In addition, the devices and subsystems of the exemplary embodiments of FIGS. 1-50 can be implemented by the preparation of application-specific integrated circuits or by interconnecting an appropriate network of conventional component circuits, as will be appreciated by those skilled in the electrical arts. Thus, the exemplary embodiments are not limited to any specific combination of hardware circuitry and/or software.

As stated above, the devices and subsystems of the exemplary embodiments of FIGS. 1-50 can include computer readable media or memories for holding instructions programmed according to the teachings of the present invention and for holding data structures, tables, records, and/or other data described herein. Computer readable media can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

In order to further minimize the overall processing time required to locate, analyze, process, shade, and render a contour region, the system of the present invention may index gridded data sets and contour regions results and store these indexed data in the contour server engine server 106. If a user anticipates that they will run the same search query in the future, the user can index the results and store the results. When an indexed and stored gridded data set is then executed, the contour levels, contour regions, shading information, and display characteristics may be retrieved for those stored data, and the relevant gridded data set may simply be updated with additional data that may now be accessible. The gridded data set previously available may be recalled from the contour server to reduce the overall execution time.

The foregoing description of exemplary aspects and embodiments of the present invention provides illustration and description, but is not intended to be exhaustive or to limit the invention to the precise form disclosed. Those of skill in the art will recognize certain modifications, permutations, additions, and combinations of those embodiments are possible in light of the above teachings or may be acquired from practice of the invention. Therefore, the present invention also covers various modifications and equivalent arrangements that would fall within the purview of appended claims and claims hereafter introduced.

The claimed invention is:

1. A computer-implemented method of rendering a contour graphic region for display, the method comprising:
obtaining a set of gridded data;
dividing the set of gridded data into tiles;
analyzing each tile sequentially to determine contour levels within each tile from lowest contour level to highest contour level;
creating a contour region based upon the determined contour levels;
shading the contour regions; and
providing the shaded contoured region for display.

2. The method of rendering a contour graphic region for display of claim 1, wherein the tiles are rectangular cells.

3. The method of rendering a contour graphic region for display of claim 2, wherein the rectangular cells include corners comprising sampled data from the set of gridded data.

4. The method of rendering a contour graphic region for display of claim 1, wherein the gridded data represents the finest grain available.

5. The method of rendering a contour graphic region for display of claim 1, wherein the contour region is not interior to a tile.

6. The method of rendering a contour graphic region for display of claim 1, wherein the step of analyzing each tile includes assigning a circular list of coordinates representing the outer perimeter of a tile.

7. The method of rendering a contour graphic region for display of claim 1, wherein the step of creating a contour region based upon the determined contour levels includes identifying polygonal bounds of the contour region.

8. The method of rendering a contour graphic region for display of claim 7, wherein the step of creating a contour region based upon the determined contour levels further includes sending the identified polygon to a renderer.

9. The method of rendering a contour graphic region for display of claim 8, wherein the step of creating a contour region based upon the determined contour levels further includes adjusting the circular list to remove coordinates that made up the polygon after sending the identified polygon to the renderer.

10. The method of rendering a contour graphic region for display of claim 1, further comprising creating a contour line within each tile based upon the determined contour levels.

11. A data storage medium with computer-executable instructions for rendering a contour graphic region for display, the data storage medium comprising:
instructions for obtaining a set of gridded data;
instructions for dividing the set of gridded data into tiles;
instructions for analyzing each tile sequentially to determine contour levels within each tile from lowest contour level to highest contour level;
instructions for creating a contour region based upon the determined contour levels;
instructions for shading the contour regions; and
instructions for providing the shaded contoured graphic region for display.

12. The data storage medium of claim 11, wherein the tiles are rectangular cells.

13. The data storage medium of claim 11, wherein the rectangular cells include corners comprising sampled data from the set of gridded data.

14. The data storage medium of claim 11, wherein the gridded data represents the finest grain available.

15. The data storage medium of claim 11, wherein the contour region is not interior to a tile.

16. The data storage medium of claim 11, wherein the instructions for analyzing each tile include instructions for assigning a circular list of coordinates representing the outer perimeter of a tile.

17. The data storage medium of claim 11, wherein the instructions for creating a contour region based upon the determined contour levels include instructions for identifying polygonal bounds of the contour region.

18. The data storage medium of claim 17, wherein the instructions for creating a contour region based upon the determined contour levels further includes instructions for sending the identified polygon to a renderer.

19. The data storage medium of claim 18, wherein the instructions for creating a contour region based upon the determined contour levels further include instructions for adjusting the circular list to remove coordinates that made up the polygon after sending the identified polygon to the renderer.

20. The data storage medium of claim 11, further comprising instructions for creating a contour line within each tile based upon the determined contour levels.

21. A system for rendering a contour graphic for display, the system comprising:
a gridded data locating module for obtaining a set of gridded data;
a dividing module for dividing the set of gridded data into tiles;
an analysis module for analyzing each tile sequentially to determine contour levels within each tile from lowest contour level to highest contour level;
a contour creation module for creating a contour region based upon the determined contour levels;
a shading module for shading the contour regions; and
a renderer for providing the shaded contoured region for display.

22. The system for rendering a contour graphic for display of claim 21, wherein the dividing module divides the set of gridded data into tiles that are rectangular cells.

23. The system for rendering a contour graphic for display of claim 22, wherein-the rectangular cells include corners comprising sampled data from the set of gridded data.

24. The system for rendering a contour graphic for display of claim 21, wherein the gridded data represents the finest grain available.

25. The system for rendering a contour graphic for display of claim 21, wherein the contour creation module creates a contour region that is not interior to a tile.

26. The system for rendering a contour graphic for display of claim 21, wherein the analysis module includes an assigning sub-module for assigning a circular list of coordinates representing the outer perimeter of a tile.

27. The system for rendering a contour graphic for display of claim 21, wherein the contour creation module includes an identification sub-module to identify polygonal bounds of the contour region.

28. The system for rendering a contour graphic for display of claim 27, wherein the contour creation module includes a transmission sub-module to send the identified polygon to a renderer.

29. The system for rendering a contour graphic for display of claim 28, wherein the contour creation module includes a coordinate tracking sub-module to adjusting the circular list to remove coordinates that made up the polygon after sending the identified polygon to the renderer.

30. The system for rendering a contour graphic region for display of claim 21, wherein the contour creation module also creates a contour line within each tile based upon the determined contour levels.
